(19) United States
(12) Patent Application Publication
(10) Pub. No.: US 2015/0334042 A1
(43) Pub. Date: Nov. 19, 2015

(54) TRAFFIC MANAGEMENT SERVER AND MANAGEMENT PROGRAM

(71) Applicant: Hitachi, Ltd., Tokyo (JP)

(72) Inventors: Rintaro KATAYAMA, Tokyo (JP); Yusuke SHOMURA, Tokyo (JP); Keisuke TAKEUCHI, Tokyo (JP); Hiroto NAKAGAWA, Tokyo (JP)

(21) Appl. No.: 14/713,396

(22) Filed: May 15, 2015

(30) Foreign Application Priority Data
May 16, 2014 (JP) 2014-101914

(51) Int. Cl. H04L 12/911; H04W 28/02; H04W 64/00

(52) U.S. Cl. CPC H04L 47/743; H04W 64/003; H04W 28/0284

(57) ABSTRACT

Provided is a technique of finely performing congestion determination and congestion control on a cellular communication system employing a C-RAN architecture. An instruction is given to a control device to acquire location information of a terminal in a cell of a C-RAN using a first message between network nodes, acquire a congestion indicator of the cell of the C-RAN using a second message between the network nodes, determine the occurrence of congestion of the cell based on the congestion indicator, identify a terminal staying in a cell in which congestion is occurring based on the location information of the terminal, and limit a maximum usable bandwidth of the specified terminal.

### CLAIM OF PRIORITY

The present application claims priority from Japanese application JP 2014-101914 filed on May 16, 2014, the content of which is hereby incorporated by reference into this application.

### FIELD OF THE INVENTION

The present invention relates to a traffic analysis and traffic control technique of a communication network.

### DESCRIPTION OF THE RELATED ART

In cellular communication systems, there are cases in which, when a load is concentrated on some network nodes or when users use a service needing a high data rate, congestion occurs. If congestion occurs, packet loss or a transmission delay increases, and thus there is a concern that a user quality is likely to deteriorate. In this regard, there are cases in which access limitation or band limitation is performed when congestion occurs.

JP 2008-516486 W discloses a method in which, in a Universal Mobile Telecommunications System (UMTS), a user plane traffic amount on an Iub or Iub/Iur interface between a radio network controller and a NodeB is controlled during an overload period of time. According to the method disclosed in JP 2008-516486 W, for each of uplink and downlink connections established on the Iub or Iub/Iur interface, an Iub or Iub/Iur load for the connection is reduced as necessary based on a result of monitoring an arrival delay of a frame transmitted on the Iub or Iub/Iur interface in the radio network controller or the NodeB through the wireless network control device.

Meanwhile, a centralized RAN or a Cloud RAN (C-RAN) has been in the spotlight as an architecture of a Radio Access Network (RAN) in a cellular communication system. In the C-RAN, Remote Radio Heads (RRHs) that transceive a radio wave are geographically apart from Baseband Units (BBUs) that perform baseband signal processing, and the RRHs installed at respective sites are connected with the BBUs aggregated at one place via an optical fiber. In the C-RAN, baseband signal processing is aggregated, and thus efficiency is expected to be increased by resource sharing or collaboration between RRHs.

### SUMMARY OF THE INVENTION

### Problem to be Solved by the Invention

As a method of determining the occurrence of congestion in a cellular communication system, a method using traffic information or signaling information of a core network acquired through a probe device is considered. For example, in Long Term Evolution (LTE) being standardized in 3rd Generation Partnership Project (3GPP), a probe device can acquire traffic information by monitoring S1-U serving as an interface between an E-UTRAN NodeB (eNodeB) and a Serving Gateway (S-GW) and SGi serving as an interface between a Packet Data Network (PDN) and a PDN Gateway (P-GW). Further, the probe device can acquire signaling information by monitoring S1-MME serving as an interface between an eNodeB and a Mobility Management Entity (MME) or S11 serving as an interface between an MME and an S-GW.

A traffic amount, a traffic type, and the like can be obtained from the acquired traffic information and used as a congestion occurrence determination criterion. Further, a location of a user generating traffic can be obtained from the acquired signaling information. For example, it is possible to obtain a user location by acquiring S1-MME or S11 signaling occurring at the time of an initial connection or a handover.

However, in the case of the C-RAN, a handover between RRHs within the same C-RAN, that is, RRHs connected to the same BBU is regarded as an Intra-eNodeB handover. In other words, since processing is terminated between user equipment (UE) and a BBU, signaling in the core network does not occur. Thus, since it is not possible to detect a movement of the user within the same C-RAN based on signaling information acquired through the probe device, the location of the user generating traffic is managed in the granularity of a C-RAN. The determination of the occurrence of congestion using the location information of the user managed in the granularity of a C-RAN is performed in the granularity of a C-RAN. The Intra-eNodeB handover is a handover between cells served by the same eNodeB, and signaling of the core network does not occur since processing is terminated between a UE and an eNodeB.

Meanwhile, in the C-RAN, there are cases in which a plurality of RRHs are arranged to be geographically apart from one another. In this circumstance, if the determination of the occurrence of congestion is performed in the granularity of a C-RAN, congestion is collectively determined to have occurred in coverage areas of the RRHs that are geographically apart. In this case, there is a concern that the user staying in an area in which congestion is not actually occurring is likely to be subject to band limitation or access limitation.

Thus, there is a demand for a technique capable of finely performing congestion determination and congestion control on a cellular communication system employing a C-RAN architecture.

### Means for Solving Problem

A representative example of the invention disclosed in this application is as follows. In other words, in a traffic management server in a cellular communication system including a C-RAN that includes a plurality of wireless transceiving devices performing communication with terminals and arranged to be geographically apart and a processing device connected to the plurality of wireless transceiving devices, the traffic management server instructs a control device configuring the cellular communication system to acquire location information of the terminal in a cell of each of the plurality of wireless transceiving devices using a first message between network nodes constituting the cellular communication system, acquire a congestion indicator of the cell using a second message between the network nodes constituting the cellular communication system, determine an occurrence of congestion of the cell based on the congestion indicator, identify a terminal staying in a cell in which the congestion is occurring based on the location information of the terminal, and limit a maximum usable bandwidth of the specified terminal.

Further, in a traffic management server in a cellular communication system including a C-RAN that includes a plurality of wireless transceiving devices performing communication with terminals and arranged to be geographically apart and a processing device connected to the plurality of wireless transceiving devices, the traffic management server instructs a control device configuring the cellular communication system to group cells that belong to the same C-RAN, are formed by the plurality of wireless transceiving devices, and are geographically adjacent as a cell cluster, acquire location information of the terminal in the cell cluster using a first message between network nodes constituting the cellular communication system, acquire a congestion indicator of the cell cluster using a second message between the network nodes constituting the cellular communication system, determine an occurrence of congestion of the cell cluster based on the congestion indicator, identify a terminal staying in a cell cluster in which the congestion is occurring based on the location information of the terminal, and limit a maximum usable bandwidth of the specified terminal.

Further, in a management program executed by a traffic management server in a cellular communication system including a C-RAN that includes a plurality of wireless transceiving devices performing communication with terminals and arranged to be geographically apart and a processing device connected to the plurality of wireless transceiving devices, the management program instructs a control device configuring the cellular communication system to acquire location information of the terminal in a cell of each of the plurality of wireless transceiving devices using a first message between network nodes constituting the cellular communication system, acquire a congestion indicator of the cell using a second message between the network nodes constituting the cellular communication system, determine an occurrence of congestion of the cell based on the congestion indicator, identify a terminal staying in a cell in which the congestion is occurring based on the location information of the terminal, and limit a maximum usable bandwidth of the specified terminal.

Further, in a management program executed by a traffic management server in a cellular communication system including a C-RAN that includes a plurality of wireless transceiving devices performing communication with terminals and arranged to be geographically apart and a processing device connected to the plurality of wireless transceiving devices, the management program instructs a control device configuring the cellular communication system to group cells that belong to the same C-RAN, are formed by the plurality of wireless transceiving devices, and are geographically adjacent as a cell cluster, acquire location information of the terminal in the cell cluster using a first message between network nodes constituting the cellular communication system, acquire a congestion indicator of the cell cluster using a second message between the network nodes constituting the cellular communication system, determine an occurrence of congestion of the cell cluster based on the congestion indicator, identify a terminal staying in a cell cluster in which the congestion is occurring based on the location information of the terminal, and limit a maximum usable bandwidth of the specified terminal.

### Effect of the Invention

According to a representative embodiment of the present invention, it is possible to finely perform congestion determination and congestion control on a cellular communication system employing a C-RAN architecture. A problem, a configuration, and an effect that are not described above will become apparent from a description of the following embodiments.

### BRIEF DESCRIPTION OF THE DRAWINGS

FIG. 1 is a diagram illustrating a configuration of a cellular communication system of a first embodiment;

FIG. 2 is a diagram illustrating a configuration of a traffic management server according to the first embodiment;

FIG. 3 is a sequence diagram for describing a procedure of managing a congestion state and a location of a user in the granularity of a cell through the traffic management server according to the first embodiment;

FIG. 4 illustrates a user information table according to the first embodiment;

FIG. 5 is a flowchart for describing a user location information update process according to the first embodiment;

FIG. 6 is a flowchart for describing a congestion indicator update process according to the first embodiment;

FIG. 7 illustrates a congestion indicator table according to the first embodiment;

FIG. 8 is a flowchart for describing a congestion determination process according to the first embodiment;

FIG. 9 is a flowchart for describing a band limitation instruction process according to the first embodiment;

FIG. 10 is a diagram illustrating a configuration of a cellular communication system according to a second embodiment;

FIG. 11 is a diagram illustrating a configuration of a traffic management server according to the second embodiment;

FIG. 12 illustrates a cell cluster information table according to the second embodiment;

FIG. 13 illustrates a cell position information table used in the second embodiment;

FIG. 14 is a flowchart for describing one of cell cluster creation processing methods according to the second embodiment;

FIG. 15 is a diagram for describing a relation between an ECGI and an eNodeB ID;

FIG. 16 illustrates a neighbor relation table used in the second embodiment;

FIG. 17 is a flowchart for describing one of cell cluster creation processing methods according to the second embodiment;

FIG. 18 is a sequence diagram for describing a method of acquiring handover history information of a terminal through a traffic management server according to the second embodiment;

FIG. 19 illustrates a handover history table used in the second embodiment;

FIG. 20 is a flowchart for describing one of cell cluster creation processing methods according to the second embodiment;

FIG. 21 is a flowchart for describing one of cell cluster creation processing methods according to the second embodiment;

FIG. 22 illustrates a mobility count table according to the second embodiment;

FIG. 23 is a flowchart illustrating a mobility count process according to the second embodiment;

FIG. 24 illustrates a user information table according to the second embodiment;

FIG. 25 is a flowchart for describing a user location information update process according to the second embodiment;

FIG. 26 is a flowchart for describing a congestion indicator update process according to the second embodiment;

FIG. 27 illustrates a congestion indicator table according to the second embodiment;

FIG. 28 is a flowchart for describing a congestion determination process according to the second embodiment;

FIG. 29 is a flowchart for describing a band limitation instruction process according to the second embodiment; and

FIG. 30 is a diagram illustrating an example of a cell arrangement for describing effects of the second embodiment.

### MODE(S) FOR CARRYING OUT THE INVENTION

### First embodiment

Hereinafter, exemplary embodiments of the present invention will be described in detail with reference to the appended drawings.

In the following embodiments, if necessary for convenience, a description will be given in a plurality of sections or embodiments, but, unless otherwise particularly specified, those sections or embodiments are not irrelevant to one another and have a relation in which one is, for example, a modified example, a detailed description, or a supplemental description of part or all of the other.

Further, in the following embodiments, when the number of elements or the like (including the number of pieces, a numerical value, a quantity, a range, and the like) is mentioned, unless otherwise particularly set forth or explicitly limited to a specific value in principle, it is not intended to be limited to the specific value but may be equal to or larger than the specific value or equal to or smaller than the specific value.

Moreover, in the following embodiments, unless otherwise particularly set forth or considered to be explicitly essential in principle, it goes without saying that constituent elements (including element steps and the like) are not necessarily essential.

In the present embodiment, LTE being standardized in 3GPP is used as an exemplary cellular communication system, and a cellular communication system in which a C-RAN forms a plurality of cells, and the cells are arranged to be geographically apart from one another is described. Further, an embodiment of a traffic management server that instructs a control device configuring a cellular communication system to manage a congestion state and a location of the user in the granularity of a cell, determine the occurrence of congestion in the granularity of a cell, identify a terminal staying in a cell in which congestion is occurring, and limit a maximum usable bandwidth of the specified terminal is described.

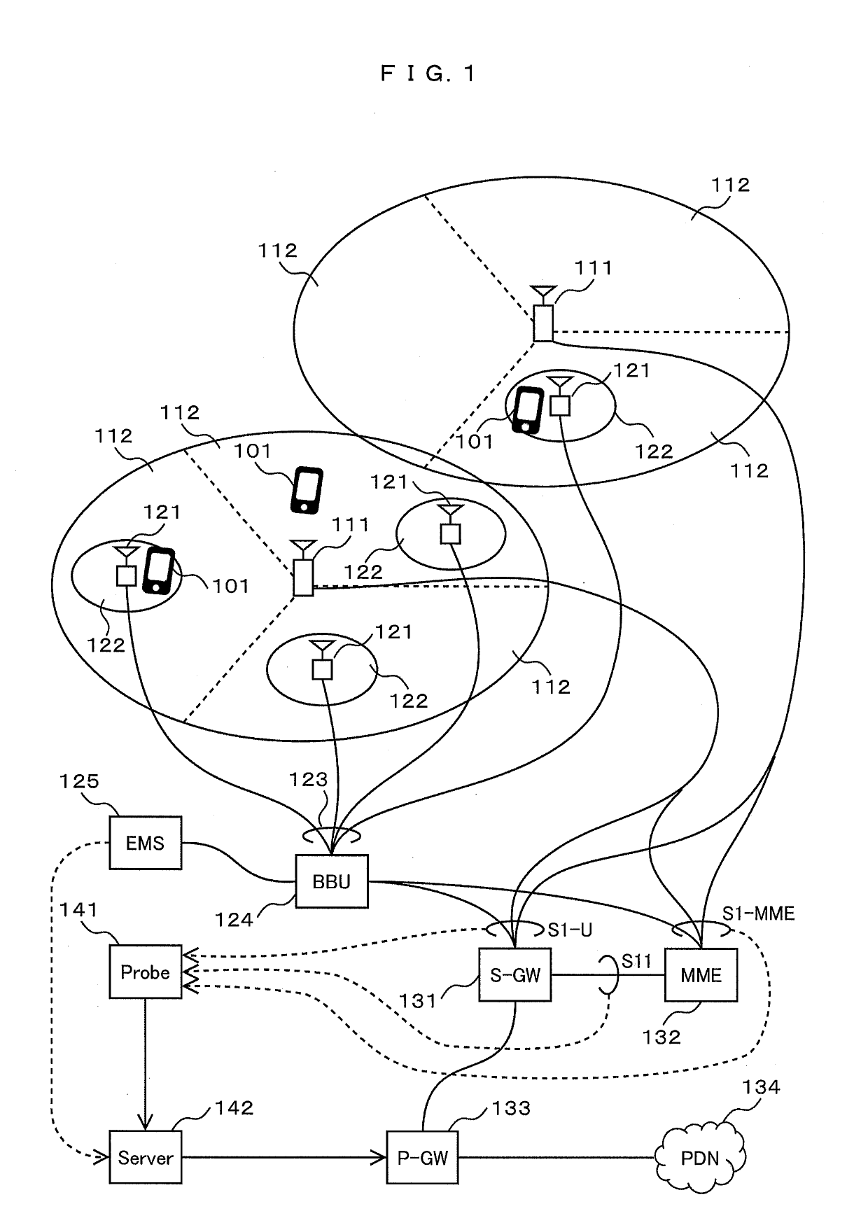

FIG. 1 is a diagram illustrating a configuration of a cellular communication system according to the present embodiment. The present system includes a UE 101 serving as user equipment, an eNodeB 111 serving as a base station device, an RRH 121, an optical fiber 123, a BBU 124, an element management system (EMS) 125 serving as a maintenance and management device, an S-GW 131, an MME 132, a P-GW 133, a probe device 141, and a traffic management server 142. The eNodeB 111 configures a cell(s) 112. The RRH 121 is a wireless transceiving device that amplifies and transceives a radio wave, and the BBU 124 is a processing device that performs baseband signal processing. The RRH 121 is connected with the BBU 124 via the optical fiber 123 to constitute the C-RAN and configure a cell 122. The cells 122 under control of the same C-RAN are arranged to be geographically apart from one another. The S-GW 131 is a gateway having a traffic transfer function of a user plane. The MME 132 is a device that manages mobility of the UE, and transceives signaling of a control plane. The P-GW 133 is a gateway having an interface with a PDN 134 that provides a service to the user. The S-GW 131, the MME 132, and the P-GW 133 are connected to one another, and constitute a core network. The probe device 141 is a device that acquires a packet on a network, and acquires traffic or signaling transceived between network nodes such as the eNodeB 111, the BBU 124, the S-GW 131, the MME 132, and the P-GW 133 or between the P-GW 133 and the PDN 134. The probe device 141 transmits information of the acquired traffic or signaling to the traffic management server 142. The traffic management server 142 decides a UE that is subject to band limitation using the information acquired from the probe device 141, and instructs the P-GW 133 to perform band limitation on a target UE.

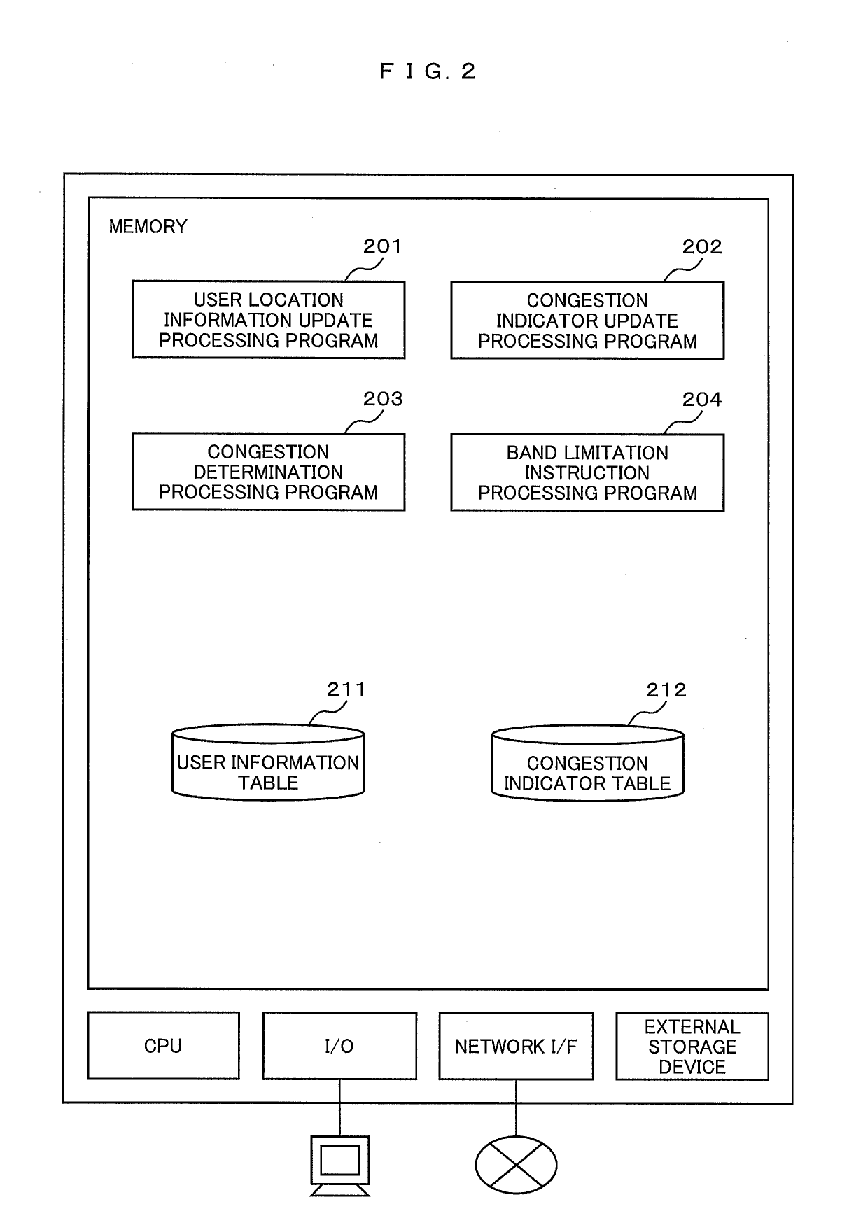

FIG. 2 is a diagram illustrating a configuration of the traffic management server 142 according to the present embodiment. A function of the traffic management server is stored in an external storage device of a general computer in the form of program software, developed onto a memory, and executed by a CPU. The traffic management server performs communication with the probe device and the P-GW via the network I/F. A memory of the traffic management server stores a user location information update processing program 201, a congestion indicator update processing program 202, a congestion determination processing program 203, and a band limitation instruction processing program 204. The memory of the traffic management server further stores a user information table 211 and a congestion indicator table 212.

In the present embodiment, the programs and the information are stored in a memory of a single computer. However, the information may be stored in an external storage device, and the information may be read from the external storage device each time processing of the programs is performed and stored in the external storage device when each processing is completed.

Alternatively, the programs and the information may be distributedly stored in a plurality of computers. For example, each of the information may be implemented as a table of a relational database and stored in a database server different from the traffic management server, and the program executed on the traffic management server may refer to and update the information in the database server.

Further, the information may be stored in a distributed key-value store (KVS) server different from the traffic management server, and the program executed on the traffic management server may refer to and update the information in the KVS server.

The difference in a storage method of the information as described above does not affect the nature of the present invention.

A feature of the traffic management server according to the present embodiment will be briefly described below. In other words, in a cellular communication system in which a C-RAN forms a plurality of cells, and the cells are arranged to be geographically apart from one another, the traffic management server instructs a control device configuring a cellular communication system to manage a congestion state and a location of the user in the granularity of a cell, determine the occurrence of congestion for each cell, identify a terminal staying in a cell in which congestion is occurring, and limit a maximum usable bandwidth of the specified terminal.

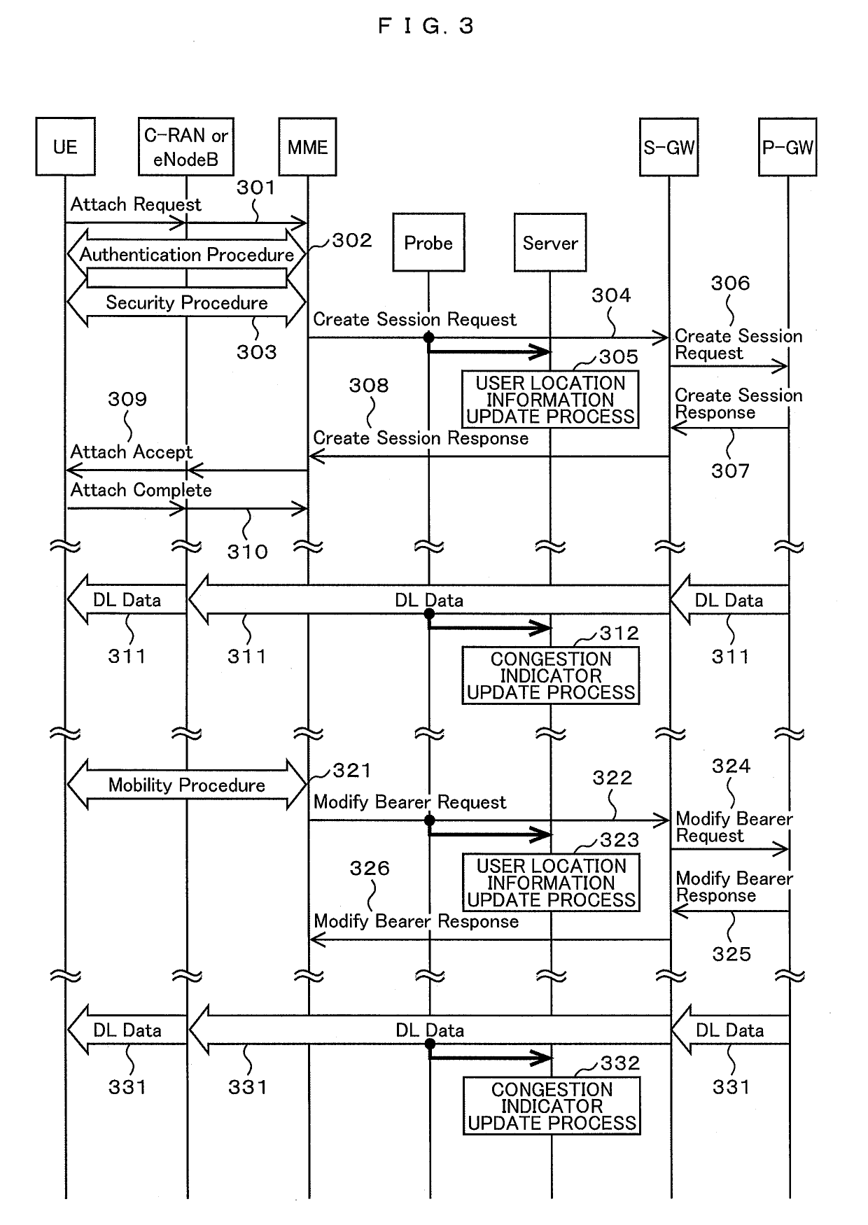

First, a procedure of managing the congestion state and the location of the user in the granularity of a cell through the traffic management server will be described with reference to FIG. 3. FIG. 3 is a sequence diagram for describing a procedure of managing the congestion state of each cell and the location of the user in the granularity of a cell.

When a new connection is set up, in sequence 301, the UE transmits an attach request message to the MME via the C-RAN or the eNodeB. Then, an authentication procedure (sequence 302) and a security procedure (sequence 303) are performed between the UE and the MME. Thereafter, in order to establish a session, in sequence 304, the MME transmits a create session request message to the S-GW. At this time, the probe device acquires the create session request message, and transfers the information to the traffic management server. In sequence 305, the traffic management server performs a user location information update process using the information of the create session request message acquired through the probe device. The S-GW transmits the create session request message to the P-GW (sequence 306), and the P-GW transmits a create session response message as a response (sequence 307). The S-GW transmits the create session response message to the MME (sequence 308). Thereafter, in sequence 309, the MME transmits an attach accept message to the UE via the C-RAN or the eNodeB. In sequence 310, the UE transmits an attach complete message to the MME via the C-RAN or the eNodeB.

After the new connection is established, traffic is transceived between the PDN and the UE. For example, in sequence 311, downlink traffic received from the PDN is transferred to the UE via the P-GW, the S-GW, and the C-RAN or the eNodeB. The probe device monitors an S1-U interface, measures a downlink traffic amount for each user, and transfers a measurement result to the traffic management server together with an S1-U fully qualified tunnel endpoint identifier (F-TEID) serving as a user identifier in the S1-U interface. The measuring of the traffic amount is preferably performed, for example, with a certain time period. In sequence 312, the traffic management server performs a congestion indicator update process using the downlink traffic amount measurement result acquired through the probe device.

When the UE moves between the different C-RANs or between the C-RAN and the eNodeB or when the UE is activated again, a mobility procedure (sequence 321) is performed between the UE and the MME. Then, in order to update bearer information, in sequence 322, the MME transmits a modify bearer request message to the S-GW. At this time, the probe device acquires the modify bearer request message, and transfers the information to the traffic management server. In sequence 323, the traffic management server performs the user location information update process using the information of the modify bearer request message acquired through the probe device. The S-GW transmits the modify bearer request message to the P-GW (sequence 324), and the P-GW transmits a modify bearer response message as a response (sequence 325). The S-GW transmits the modify bearer response message to the MME (sequence 326).

Thereafter, in sequence 331, traffic is transceived between the PDN and the UE, and in sequence 332, the traffic management server performs the congestion indicator update process using the downlink traffic amount measurement result acquired through the probe device.

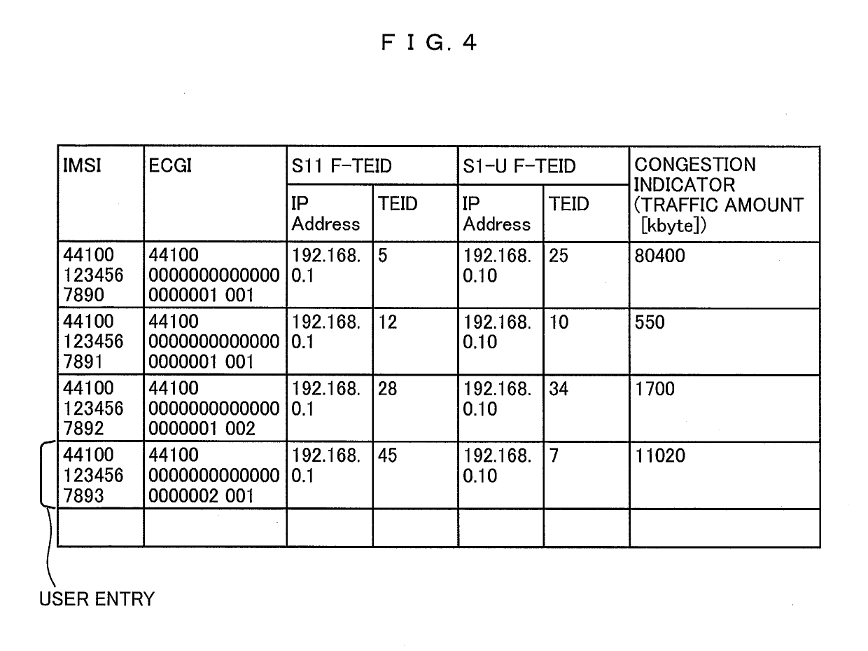

FIG. 4 illustrates the user information table 211 storing a user entry including the user location information and the congestion indicator. The user entry includes an international mobile subscriber identity (IMSI), an E-UTRAN cell global identifier (ECGI), an S11 F-TEID, an S1-U F-TEID, and a congestion indicator. The S11 F-TEID includes an IP address and a TEID serving as an identifier of an S11 tunnel. The S1-U F-TEID includes an IP address and a TEID serving as an identifier of an S1-U tunnel. The congestion indicator refers to a traffic amount in the example of FIG. 4.

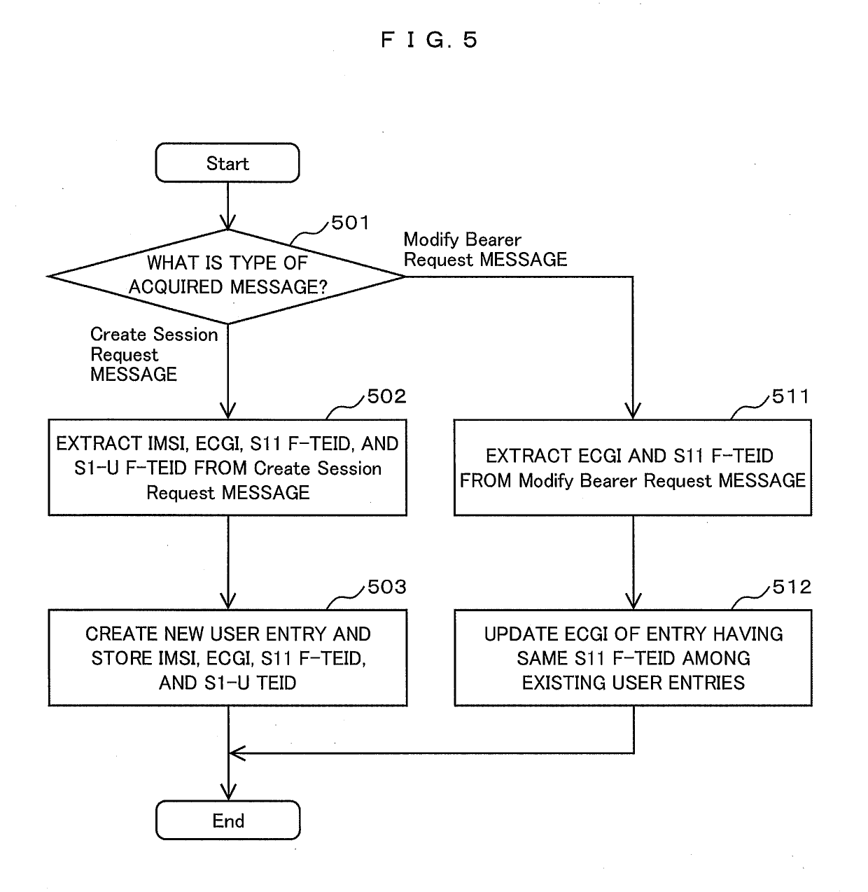

The user location information update process performed in sequences 305 and 323 will be described with reference to FIG. 5. FIG. 5 is a flowchart illustrating a procedure of the user location information update process performed through the user location information update processing program 201 executed by the traffic management server. In step 501, the traffic management server determines whether the message acquired through the probe device is the create session request message or the modify bearer request message. When the message acquired through the probe device is the create session request message, in step 502, the traffic management server extracts an IMSI serving as a unique user identifier, an ECGI serving as a cell identifier, an S11 F-TEID serving as a user identifier in the S11 interface, and an S1-U F-TEID serving as a user identifier in the S1-U interface from the create session request message. Then, in step S503, the traffic management server stores the extracted IMSI, the ECGI, the S11 F-TEID, and the S1-U F-TEID in the user information table 211 as a new user entry.

On the other hand, when the message acquired through the probe device is determined to be the modify bearer request message in step 501, in step 511, the traffic management server extracts the ECGI and the S11 F-TEID from the modify bearer request message. Then, in step 512, the traffic management server updates the ECGI of the entry having the same S11 F-TEID as the S11 F-TEID extracted in step 511 among the user entries of the user information table 211 to the ECGI extracted in step 511. As described above, the ECGI is extracted from the modify bearer request message transmitted as the UE moves between the different C-RANs or between the C-RAN and the eNodeB or when the UE is activated again, and the update is performed using the extracted ECGI. Accordingly, it is possible to manage the location of the user in the granularity of a cell.

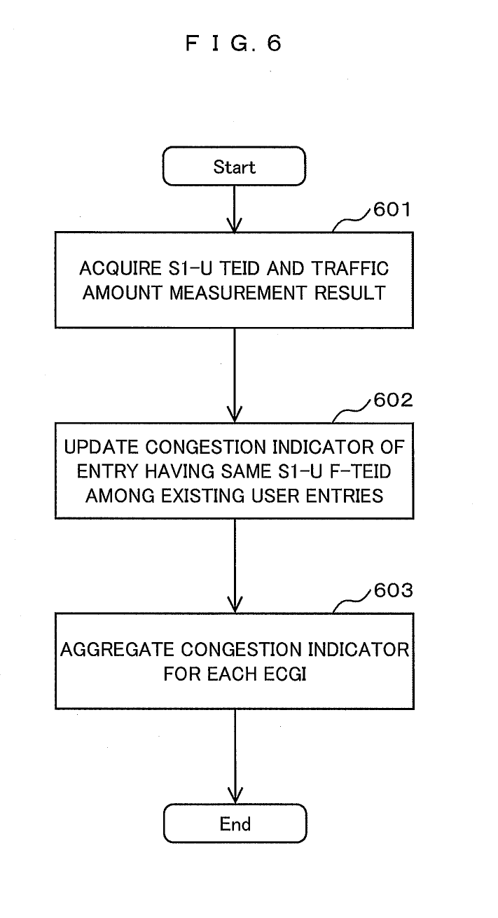

The congestion indicator update process performed in sequences 312 and 332 will be described with reference to FIG. 6. FIG. 6 is a flowchart illustrating a procedure of the congestion indicator update process performed through the congestion indicator update processing program 202 executed by the traffic management server. In step 601, the traffic management server acquires the S1-U TEID and the traffic amount measurement result from the probe device. In step 602, the traffic management server updates the congestion indicator of the entry having the same S1-U F-TEID as the S1-U F-TEID extracted step 601 among the user entries of the user information table 211 to the traffic amount measurement result acquired in step 601. Further, in step 603, the traffic management server aggregates the congestion indicators of the entries having the same ECGI among the user entries of the user information table 211, and stores the aggregation result in the congestion indicator table 212.

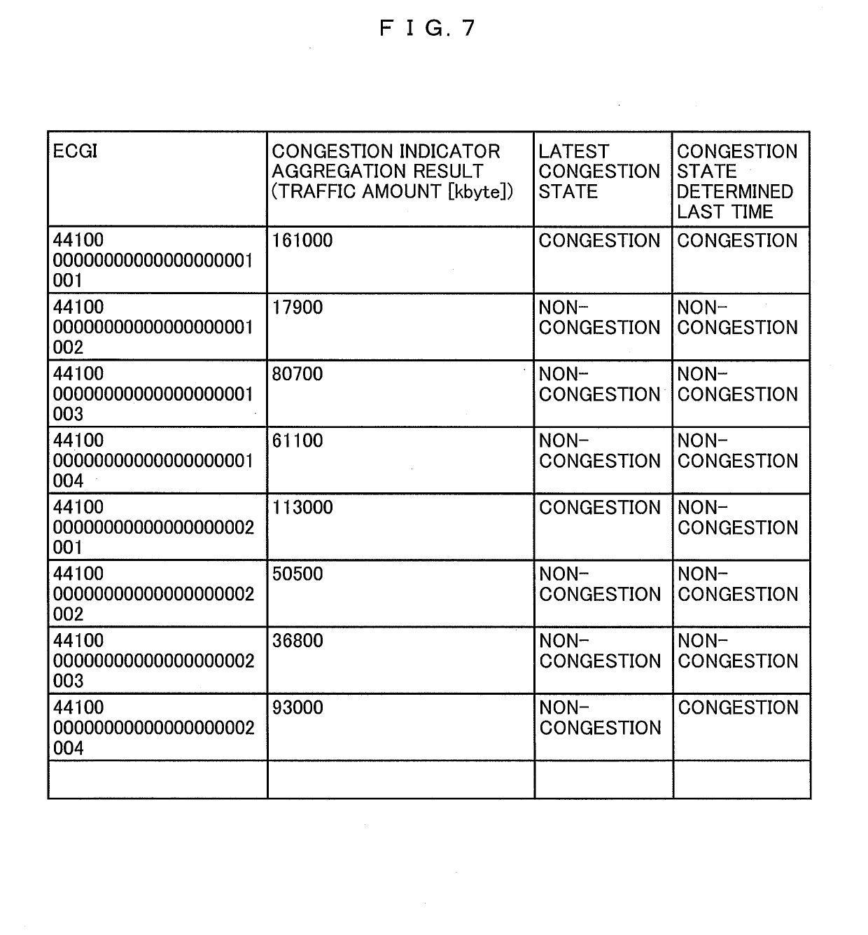

FIG. 7 illustrates the congestion indicator table 212. The congestion indicator table holds the congestion indicator aggregation result and the congestion state for each user, that is, for each ECGI.

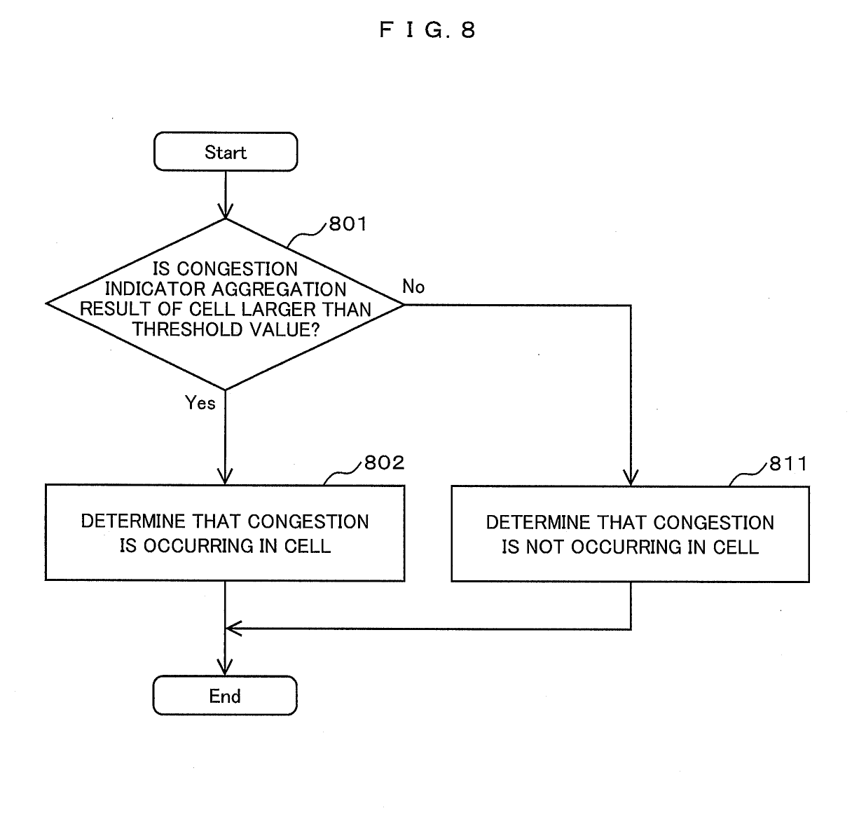

Next, a procedure of determining the occurrence of congestion in the granularity of a cell through the traffic management server will be described with reference to FIG. 8. FIG. 8 is a flowchart illustrating a procedure of a congestion determination process performed through the congestion determination processing program 203 executed by the traffic management server. In step 801, the traffic management server determines whether or not the congestion indicator aggregation result of the cell stored in the congestion indicator table 212 is larger than a threshold value. For example, the threshold value used in step 801 may be set in advance by a network administrator or may be set by the traffic management server. When the congestion indicator aggregation result of the cell is larger than the threshold value (Yes in step 801), in step 802, the traffic management server determines that congestion is occurring in the cell, and sets the congestion state of the cell in the congestion indicator table 212 to “congestion.” When the congestion indicator aggregation result of the cell is not larger than the threshold value (No in step 801), in step 811, the traffic management server determines that congestion is not occurring in the cell, and sets the congestion state of the cell in the congestion indicator table 212 to “non-congestion.” This process is performed on each of the cells managed through the congestion indicator table 212. The congestion indicator table 212 further holds a latest congestion determination result and an immediately previous congestion determination result. The determining of the occurrence of congestion is preferably performed, for example, with a certain time period.

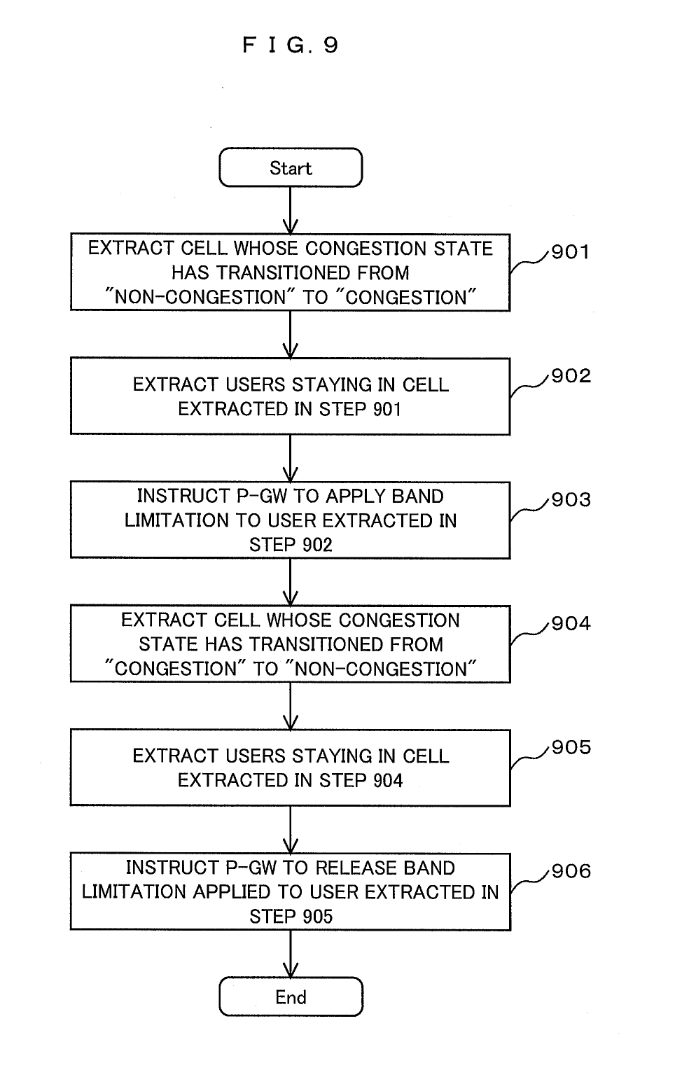

A procedure in which the traffic management server instructs the control device configuring the cellular communication system to identify a terminal staying in a cell in which congestion is occurring and limit a maximum usable bandwidth of the specified terminal will be described with reference to FIG. 9. FIG. 9 is a flowchart illustrating a procedure of a band limitation instruction process performed through the band limitation instruction processing program 204 executed by the traffic management server. In step 901, the traffic management server extracts a cell (an ECGI) whose congestion state has transitioned from “non-congestion” to “congestion” with reference to the latest congestion state and the congestion state determined last time in the congestion indicator table 212. Then, in step 902, the traffic management server extracts a user (an IMSI) staying in the cell (the cell that has entered the congestion state) extracted in step 901 with reference to the user information table 211. In step 903, the traffic management server instructs the P-GW to apply the band limitation to the user (the IMSI) extracted in step 902. For example, the applying of the band limitation is performed by setting a maximum bit rate allowed to the user. Alternatively, when the maximum bit rate is set even in the non-congestion state, the band limitation is performed by setting a maximum bit rate of a smaller value. Further, in step 904, the traffic management server extracts a cell (an ECGI) whose congestion state has transitioned from “congestion” to “non-congestion” with reference to the latest congestion state and the congestion state determined last time in the congestion indicator table 212. Then, in step 905, the traffic management server extracts a user (an IMSI) staying in the cell (the cell that has entered the non-congestion state) extracted in step 904 with reference to the user information table 211. In step 906, the traffic management server instructs the P-GW to release the band limitation applied to the user (the IMSI) extracted in step 905.

In the above description, the traffic management server extracts the information element from the message, but the probe device may extract the information element and then transfer the extracted information to the traffic management server.

Further, in the above description, the information element is extracted from the message transceived through the S11 serving as the interface between the MME and the S-GW, but the information element may be extracted from the message transceived through any other interface such as an S1-MME serving as the interface between the MME and the BBU (or the eNodeB).

Further, in the above description, the downlink traffic amount is used as the congestion indicator, but any other index may be used. For example, a transmission delay amount, a data rate, or the number of connected users may be used as the congestion indicator. For example, the probe device can acquire the transmission delay amount, the data rate, or the number of connected users by monitoring traffic on the S1-U interface. Alternatively, information related to uplink traffic may be used as the congestion indicator.

Further, in the above description, two levels of states, that is, “congestion” and “non-congestion” are used as the congestion state, but three or more levels of congestion states may be defined. When three or more levels of congestion states are defined, a different upper limit value can be used in subsequent band limitation according to a degree of congestion of a cell. For example, a maximum bit rate allowed to the user when a degree of congestion is low is set to a value larger than a maximum bit rate allowed to the user when a degree of congestion is high. As a result, it is possible to slow down a change in the maximum bit rate associated with a variation in the congestion state and thus prevent the band limitation from affecting a user service.

Further, in the above description, the band limitation is applied to all the users staying in the cell in which congestion is occurring, but the band limitation may be applied to some users. For example, a preferred user may be registered in a traffic management device in advance, and the traffic management device may exclude the preferred user from the band limitation target. Alternatively, a specific traffic type that is desired to be subject to the band limitation may be registered in the traffic management device in advance, and the traffic management device may set only the user that is performing transmission and reception of the specific traffic type as the band limitation target.

In FIG. 1, the cells 122 under control of the same C-RAN are arranged to be geographically apart. It is difficult to detect a movement within the C-RAN through the probe device as described above, but in the cell arrangement of FIG. 1, there is no movement within the C-RAN, and a handover between the cell 122 under control of the C-RAN and any other neighboring cell is consistently an Inter-eNB handover that can be detected by the probe device. In other words, in the cell arrangement of FIG. 1, by applying the present embodiment, the traffic management server can manage a cell of the C-RAN in which the user stays. As a result, the traffic management server can detect the congestion state in the granularity of a cell and determine whether or not the band limitation is performed in the granularity of a cell. Thus, the problem in that if the congestion occurrence determination is performed in units of C-RANs, when congestion is collectively determined to have occurred in coverage areas of the RRHs that are geographically apart, a band limitation or an access limitation is performed on the user staying in an area in which congestion is not actually occurring is solved.

### Second embodiment

In the first embodiment, since the cell's under control of the same C-RAN are arranged to be geographically apart as described in FIG. 1, a handover between the cell 122 under control of the C-RAN and any other neighboring cell is consistently an Inter-eNB handover that can be detected by the probe device. On the other hand, when the cells under control of the same C-RAN are densely arranged, there is a movement within the C-RAN that is hardly detected by the probe device. In this regard, in the present embodiment, the cells under control of the same C-RAN that are geographically adjacent to one another are grouped as a cell cluster, and the user location or the congestion state is managed in units of cell clusters.

In the present embodiment, LTE being standardized in 3GPP is used as an exemplary cellular communication system, and an embodiment of a traffic management server that instructs the control device configuring the cellular communication system to manage the congestion state and the location of the user in units of cell clusters, determine the occurrence of congestion in units of cell clusters, identify a terminal staying in a cell cluster in which congestion is occurring, and limit a maximum usable bandwidth of the specified terminal is described.

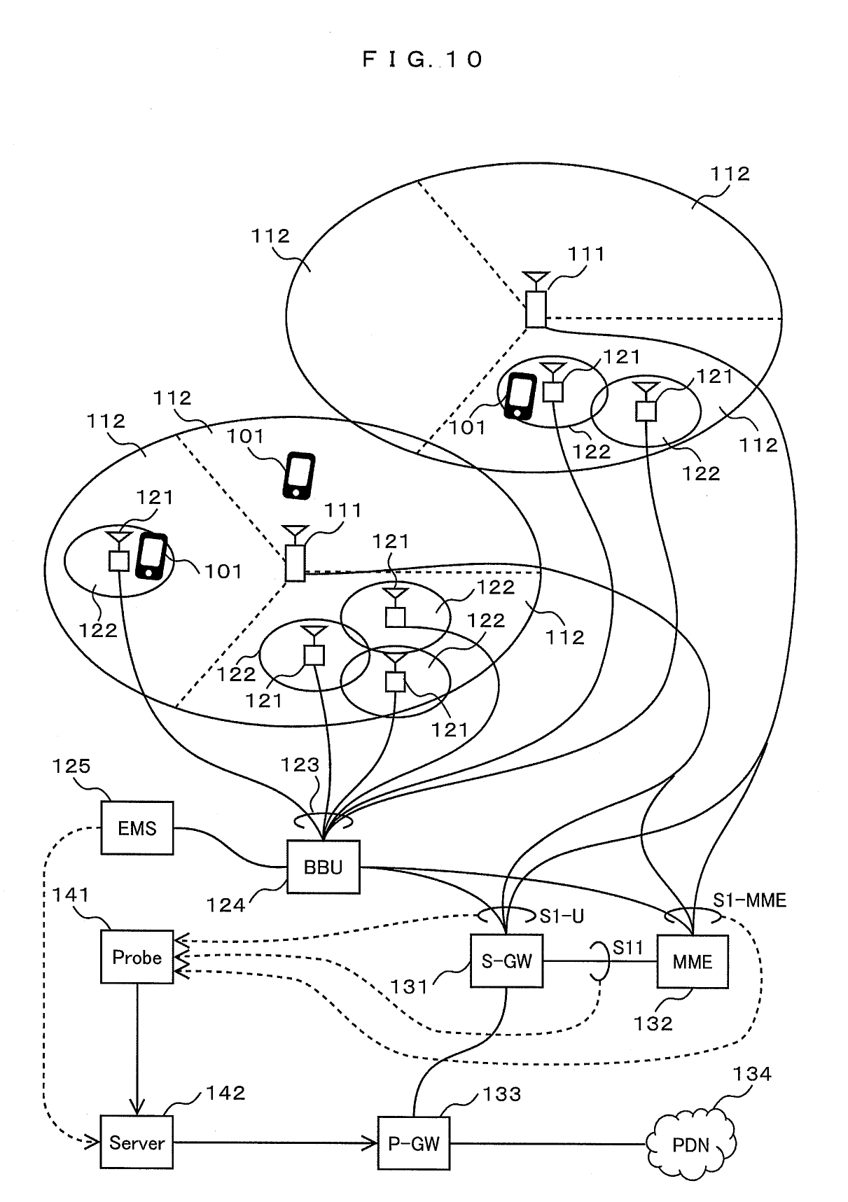

FIG. 10 is a diagram illustrating a configuration of a cellular communication system according to the present embodiment. Constitutional elements of the system of FIG. 10 are the same as the constitutional elements of the first embodiment described above with reference to FIG. 1. Thus, a description thereof is omitted herein. Referring to FIG. 10, several cells under control of the C-RAN are geographically adjacent to one another.

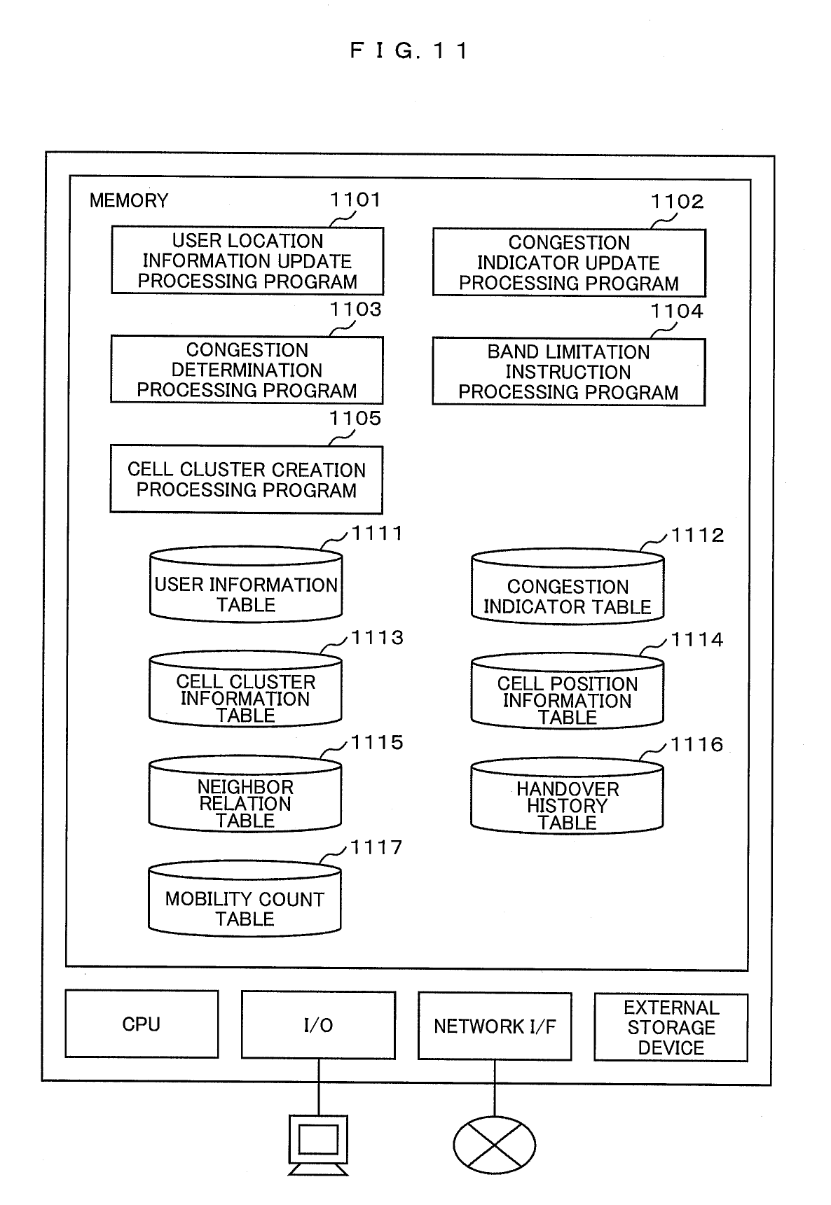

FIG. 11 is a diagram illustrating a configuration of the traffic management server 142 according to the present embodiment. A function of the traffic management server is stored in an external storage device of a general computer in the form of program software, developed onto a memory, and executed by a CPU. The traffic management server performs communication with the probe device and the P-GW via the network I/F. The memory of the traffic management server includes a user location information update processing program 1101, a congestion indicator update processing program 1102, a congestion determination processing program 1103, a band limitation instruction processing program 1104, and a cell cluster creation processing program 1105. The memory of the traffic management server further stores a user information table 1111, a congestion indicator table 1112, a cell cluster information table 1113, a cell position information table 1114, a neighbor relation table (NRT) 1115, a handover history table 1116, and a mobility count table 1117.

In the present embodiment, the programs and the information are stored in a memory of a single computer. However, the information may be stored in an external storage device, and the information may be read from the external storage device each time processing of the programs is performed and stored in the external storage device when each processing is completed.

Alternatively, the programs and the information may be distributedly stored in a plurality of computers. For example, each of the information may be implemented as a table of a relational database and stored in a database server different from the traffic management server, and the program executed on the traffic management server may refer to and update the information in the database server.

Further, the information may be stored in a distributed KVS server different from the traffic management server, and the program executed on the traffic management server may refer to and update the information in the KVS server.

The difference in a storage method of the information as described above does not affect the nature of the present invention.

A feature of the traffic management server according to the present embodiment will be briefly described below. In other words, the traffic management server instructs the control device configuring the cellular communication system to create a cell cluster, manage the congestion state and the location of the user in units of cell clusters, determines the occurrence of congestion in units of cell clusters, identify a terminal staying in a cell cluster in which congestion is occurring, and limit the maximum usable bandwidth of the specified terminal.

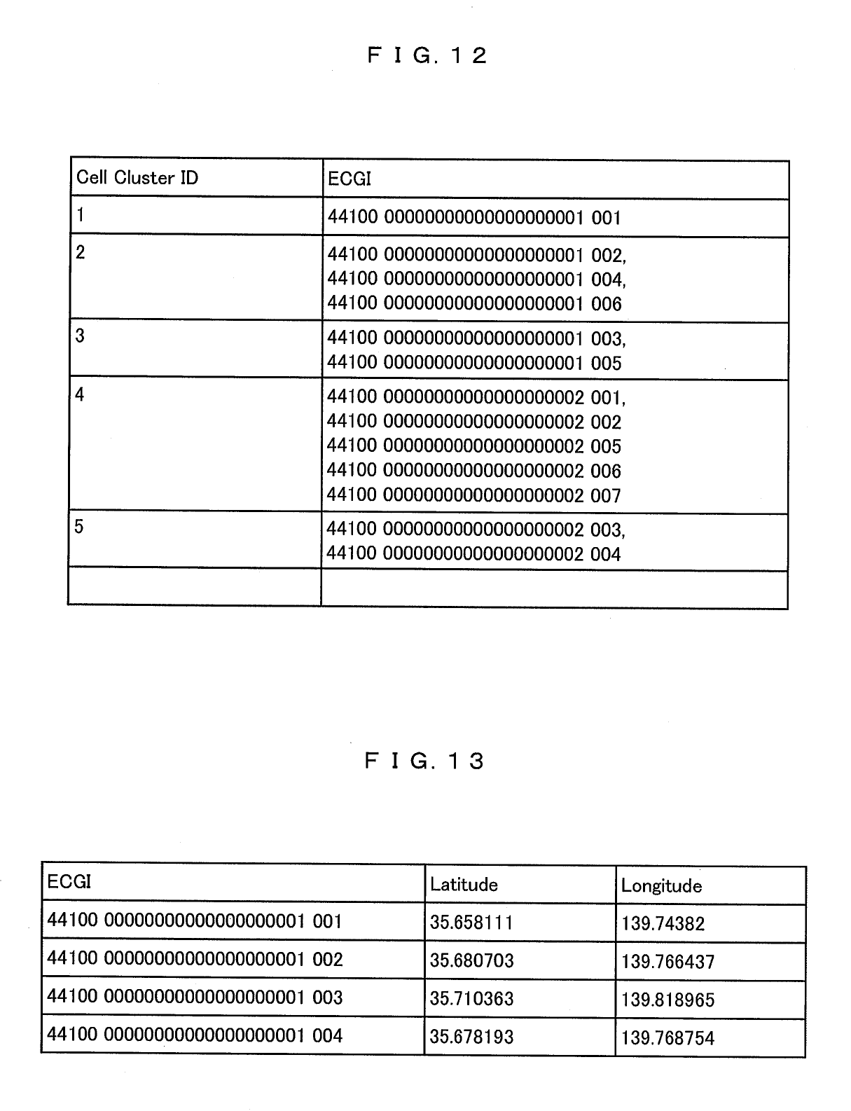

First, a cell cluster creation procedure will be described. The traffic management server groups adjacent cells among the cells under control of the same C-RAN, and stores the grouped cells in the cell cluster information table. FIG. 12 illustrates the cell cluster information table 1113 maintained in the traffic management server. The cell cluster information table 1113 includes a cell cluster ID serving as an identifier of a cell cluster and ECGIs of cells constituting each cell cluster. The cell cluster consists of one or more cells.

The cell cluster information table 1113 may be registered in the traffic management server in advance. Alternatively, the traffic management server may create the cell cluster information table 1113 using the information acquired from the EMS serving as the maintenance and management device of the C-RAN. Alternatively, the traffic management server may create the cell cluster information table 1113 using the information acquired from the probe device.

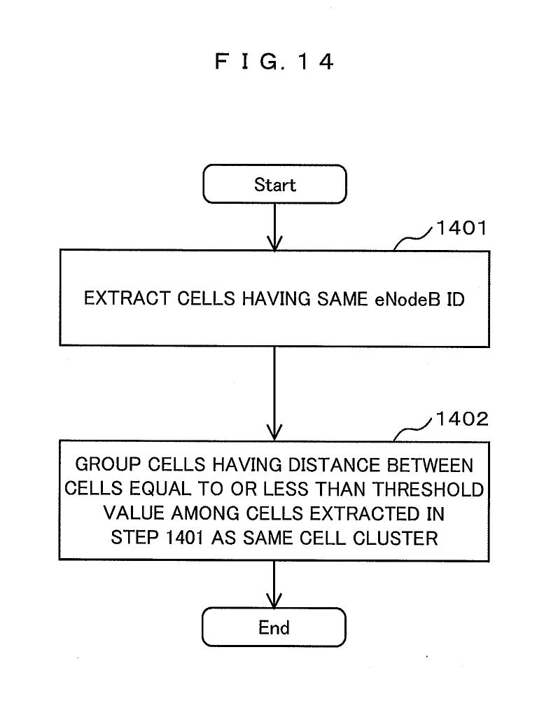

As a method in which the traffic management server creates the cell cluster information table 1113 using the information acquired from the EMS serving as the maintenance and management device of the C-RAN, a method using position information of a cell will be described with reference to FIGS. 13 and 14. FIG. 13 illustrates the cell position information table 1114 that the traffic management server acquires from the EMS, and the cell position information table 1114 holds latitude information and longitude information for each ECGI. FIG. 14 is a flowchart of a cell cluster creation process performed through the cell cluster creation processing program 1105 executed by the traffic management server using the position information of the cell.

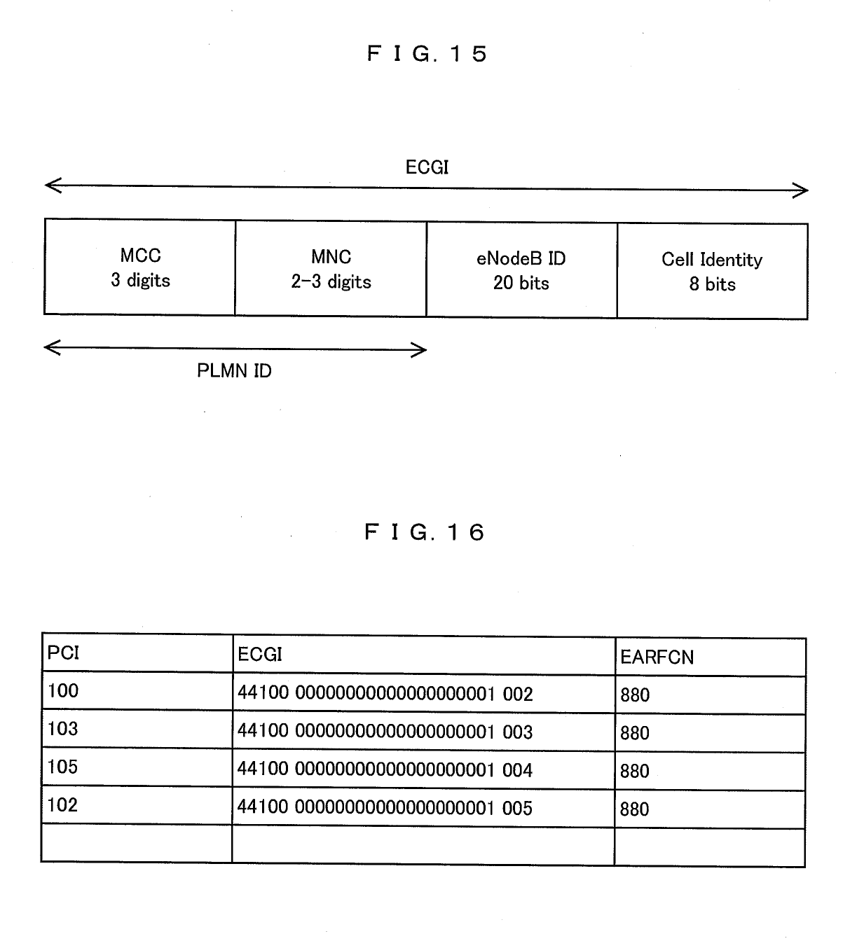

Referring to FIG. 14, in step 1401, the traffic management server extracts cells belonging to the same C-RAN (or the eNodeB), that is, cells having the same eNodeB ID from the ECGI stored in the cell position information table 1114. FIG. 15 is a diagram illustrating a relation between the ECGI and the eNodeB ID. As illustrated in FIG. 15, the ECGI includes a public land mobile network identifier (PLMN ID) configured with a mobile country code (MCC) and a mobile network code (MNC), an eNodeB ID serving as an identifier of the C-RAN or the eNodeB, and a cell identity serving as an identifier of a cell under control of the C-RAN or the eNodeB. Thus, the traffic management server can determine that the cells have the same eNodeB ID based on the ECGI. Then, in step 1402, the traffic management server calculates a distance between the cells using the cell position information table 1114 for the cells having the same eNodeB ID extracted in step 1401, and groups the cells in which the distance between the cells is equal to or smaller than a threshold value as the same cell cluster. In this method, it is possible to accurately group the cells that are geographically adjacent to one another as the cell cluster using the position information of the cell. It is possible to create the cell cluster with a high degree of accuracy by deciding the threshold value of the distance between the cells according to a cell coverage (or based on cell transmission power).

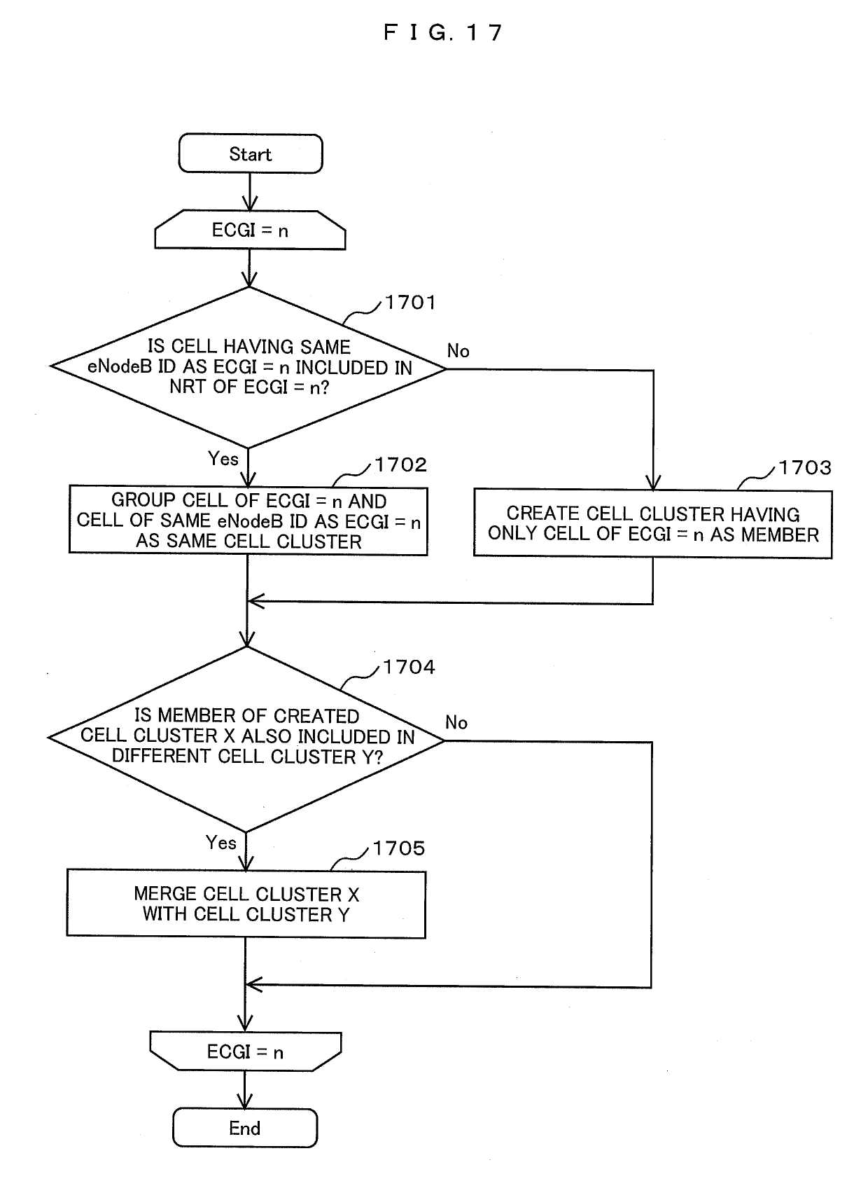

As another method in which the traffic management server creates the cell cluster information table 1113 using the information acquired from the EMS serving as the maintenance management device of the C-RAN, a method using the neighbor relation table (NRT) including a neighbor relation of cells will be described with reference to FIGS. 16 and 17. FIG. 16 illustrates an example of the NRT 1115 that the traffic management server acquires from the EMS. The NRT 1115 is a list of cells adjacent to a cell of the ECGI=n with respect to a certain cell (ECGI=n). The NRT 1115 includes at least the ECGI. The NRT 1115 may include a physical cell identity (PCI) serving as a cell identifier used in a wireless link and an E-UTRA absolute radio frequency channel number (EARFCN) serving as a channel number of a radio frequency channel. The traffic management server holds the NRT 1115 for each ECGI. FIG. 17 is a flowchart of a cell cluster creation process performed through the cell cluster creation processing program 1105 executed by the traffic management server using the NRT. Referring FIG. 17, in step 1701, the traffic management server determines whether or not a cell having the same eNodeB ID as the ECGI=n is included in the NRT of the certain cell (the ECGI=n). As described above in the procedure of FIG. 14, the traffic management server can determine that the cell has the same eNodeB ID based on the ECGI. When the cell having the same eNodeB ID as the cell of the ECGI=n is included in the NRT of the ECGI=n (Yes in step 1701), in step 1702, the traffic management server groups the cell of the ECGI=n and all the cells having the same eNodeB ID as the cell of the ECGI=n as the same cell cluster (a cell cluster X). When the cell having the same eNodeB ID as the cell of the ECGI=n is not included in the NRT of the ECGI=n (No in step 1701), in step 1703, the traffic management server creates a cell cluster (the cell cluster X) having only the cell of the ECGI=n as a member. Then, in step 1704, the traffic management server determines whether or not the cell serving as the member of the cell cluster X is also included in a previously created cell cluster Y. When the cell serving as the member of the cell cluster X is also included in the previously created cell cluster Y (Yes in step 1704), in step 1705, the traffic management server merges the cell cluster X with the cell cluster Y. The traffic management server performs this process on all the ECGIs under control of the C-RAN. In this method, the traffic management server can create the cell cluster without acquiring the information of the cell position from the EMS.

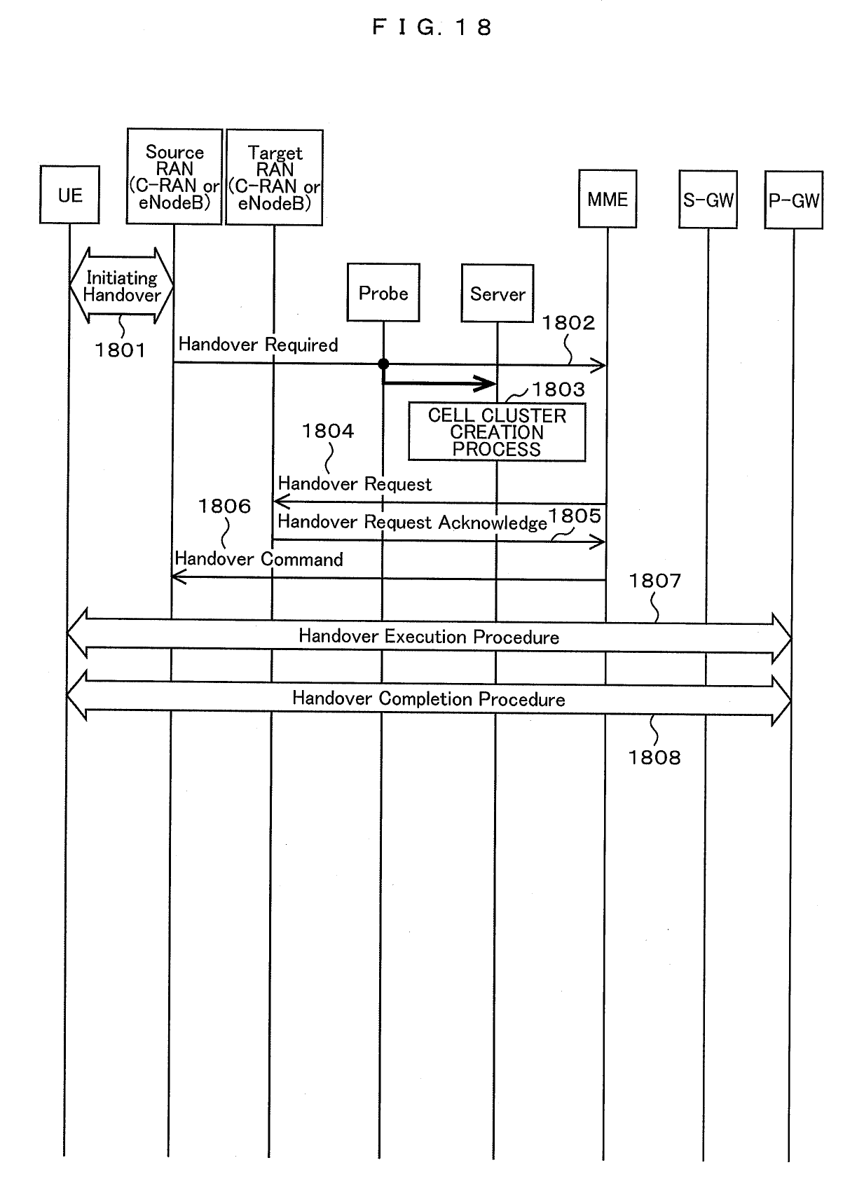

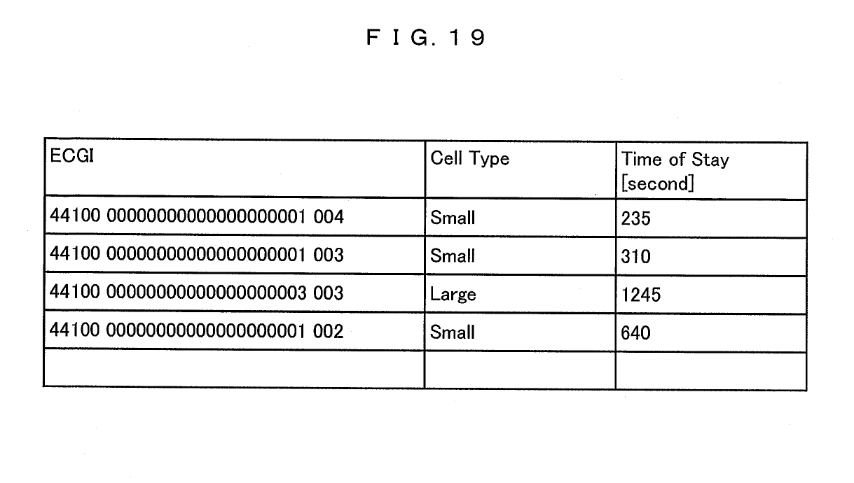

As a method in which the traffic management server creates the cell cluster information table 1113 using the information acquired from the probe device, a method using handover history of a terminal will be described. First, a method of acquiring handover history information of a terminal through the traffic management server will be described with reference to FIGS. 18 and 19. FIG. 18 is a sequence diagram for describing a procedure in which the traffic management server acquires handover history information of a terminal from signaling generated when a UE performs a handover. Referring to FIG. 18, in sequence 1801, a handover is activated. In sequence 1802, a source (handover source) RAN (the C-RAN or the eNodeB) transmits a handover required message to the MME. At this time, the probe device acquires the handover required message, and transfers this information to the traffic management server. In sequence 1803, the traffic management server performs the cell cluster creation process using the information of the handover required message acquired through the probe device. The MME transmits a handover request message to a target (handover target) RAN (the C-RAN or the eNodeB) (sequence 1804), the target RAN transmits a handover request acknowledge message (sequence 1805), and the MME transmits a handover command message to the source RAN (sequence 1806). Thereafter, in a handover execution procedure of sequence 1807, the UE switches a connection destination from the source RAN to the target RAN, and data transfer from the source RAN to the target RAN is performed. Further, in a handover completion procedure of sequence 1808, switching of a bearer for transferring traffic is performed.

The traffic management server extracts the handover history of the terminal from the handover required message acquired through the probe device, and holds the extracted handover history as the handover history table. Further, the handover history information is updated and held by the base station each time a connection destination cell of the UE is changed, including the handover within the same C-RAN, and the handover history information is included in the handover required message and transmitted.

FIG. 19 illustrates the handover history table 1116 for a certain UE held in the traffic management server. The handover history table 1116 includes information of cells in which the UE has stayed in the past in the order that the terminal has stayed. In the example of FIG. 19, a cell of a first row is a cell in which a terminal has stayed at a closest position. In other words, cells of rows next to each other in the handover history table 1116 are estimated to be geographically adjacent. The cell information of the handover history table 1116 includes at least the ECGI. The cell information of the handover history table 1116 may include a cell type and a time of stay. For example, the traffic management server holds the handover history information for each UE or for each handover required message. In the following description, the traffic management server is assumed to hold the handover history information for each UE.

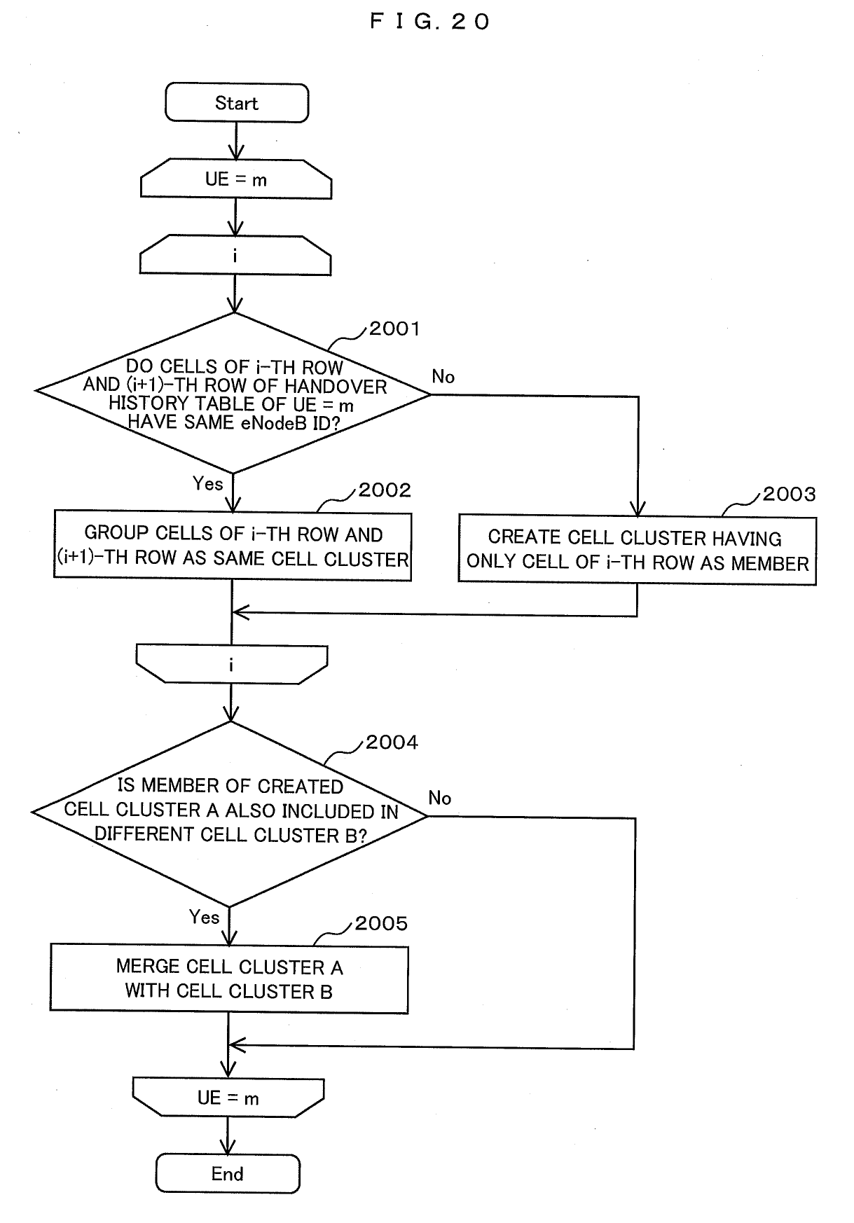

Next, a method in which the traffic management server creates the cell cluster information table 1113 using the handover history information of the terminal will be described with reference to FIG. 20. FIG. 20 is a flowchart of a cell cluster creation process performed through the cell cluster creation processing program 1105 executed by the traffic management server using the handover history of the terminal. Referring to FIG. 20, in step 2001, the traffic management server determines whether or not the cell of the i-th row and the cell of the (i+1)-th row of the handover history table of the UE=m have the same eNodeB ID. As described above in the procedure of FIG. 14, the traffic management server can determine the cells have the same eNodeB ID based on the ECGI. When the cell of the i-th row and the cell of the (i+1)-th row of the handover history table of the UE=m have the same eNodeB ID (Yes in step 2001), the traffic management server groups the cell of the i-th row and the cell of the (i+1)-th row as the same cell cluster. When the cell of the i-th row and the cell of the (i+1)-th row of the handover history table of the UE=m do not have the same eNodeB ID (No in step 2001), the traffic management server creates a cluster including only the cell of the i-th row. The traffic management server performs this process on all the rows of the handover history table of the UE=m. Then, in step 2004, the traffic management server determines whether or not a cell serving as a member of a cell cluster A is also included in another cell cluster B. When the cell serving as the member of the cell cluster A is included in another cell cluster B (Yes in step 2004), in step 2005, the traffic management server merges the cell cluster A with the cell cluster B. The traffic management server performs this process on the handover history tables of the UEs managed by the C-RAN. In this method, the traffic management server can create the cell cluster without acquiring the information from the EMS. In this method, it is necessary to acquire signal of the S1-MME interface between the RAN and the MME, but it is possible to create the cell cluster with a relatively high degree of accuracy.

Further, in the example of FIG. 20, when the cells having the same eNodeB ID are adjacent to each other in the handover history table, the cells are necessarily grouped as the same cell cluster, but grouping for the cell cluster may be performed based on the frequency in which the cells having the same eNodeB ID are adjacent to each other in the handover history table. For example, the number of times in which a pair of cells having the same eNodeB ID are adjacent to each other in the handover history table may be counted, and the pair of cells having the counted number of times equal to larger than a threshold value may be determined to belong to the same cell cluster.

Further, in the example of FIG. 20, the traffic management server is assumed to use the handover history tables of all the UEs, but may use the handover history tables of some UEs.

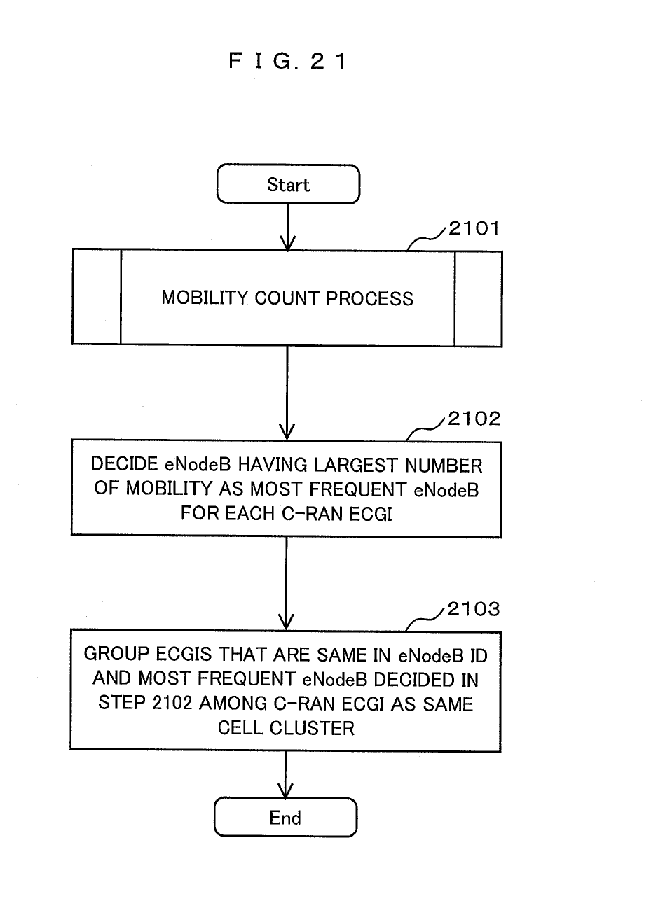

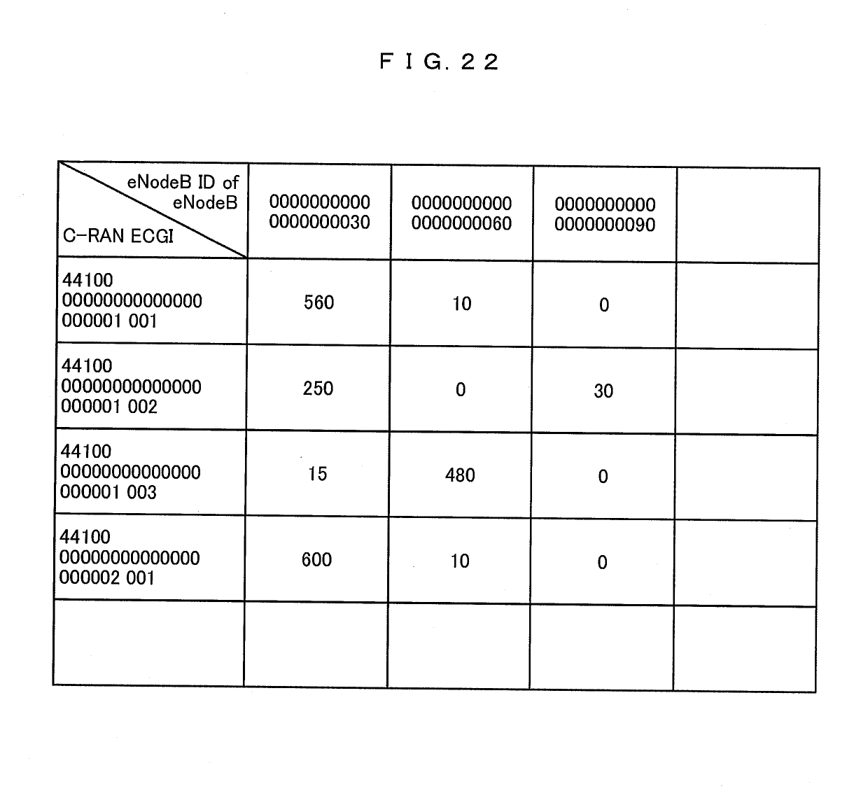

As a method in which the traffic management server creates the cell cluster information table 1113 using the information acquired from the probe device, a method using the number of movements of the terminal between the C-RAN and the eNodeB will be described with reference to FIGS. 21 and 22. FIG. 21 is a flowchart of a cell cluster creation process performed through the cell cluster creation processing program 1105 executed by the traffic management server using the number of movements of the terminal between the C-RAN and the eNodeB. FIG. 22 illustrates the mobility count table 1117 held in the traffic management server.

Referring to FIG. 21, in step 2101, the traffic management server performs a mobility count process which will be described later. As a result of the mobility count process, the mobility count table 1117 of FIG. 22 is created. The mobility count table 1117 stores the number of detections of a user movement (the number of mobility) from each eNodeB (the eNodeB ID of the eNodeB) to the ECGI, for each ECGI (the C-RAN ECGI) under control of the C-RAN. In step 2102, the traffic management server determines the eNodeB having the largest number of mobility as the most frequent eNodeB for each ECGI under control of the C-RAN. For example, in the example of FIG. 22, the most frequent eNodeB of a C-RAN ECGI=44100 00000000000000000001 001 of a first row is the eNodeB ID=00000000000000000030 of a first column (560 times). Thereafter, in step 2103, the traffic management server groups the ECGIs that are the same in the eNodeB ID of the ECGI and the most frequent eNodeB decided in step 2102 among the ECGI under control of the C-RAN as the same cell cluster. In the example of FIG. 22, the C-RAN ECGI=44100 00000000000000000001 001 of the first row and a C-RAN ECGI=44100 00000000000000000001 002 of a second row are the same in the eNodeB ID (the eNodeB ID=00000000000000000001) and the most frequent eNodeB (the eNodeB ID=00000000000000000030 of the first column), and thus the two C-RAN ECGIs are grouped as the same cell cluster. On the other hand, a C-RAN ECGI=44100 00000000000000000002 001 of a fourth row is the same in the most frequent eNodeB as the C-RAN ECGIs of the first and second rows but different in the eNodeB ID included in the C-RAN ECGI from the C-RAN ECGIs of the first and second rows, and thus they are not grouped as the same cell cluster.

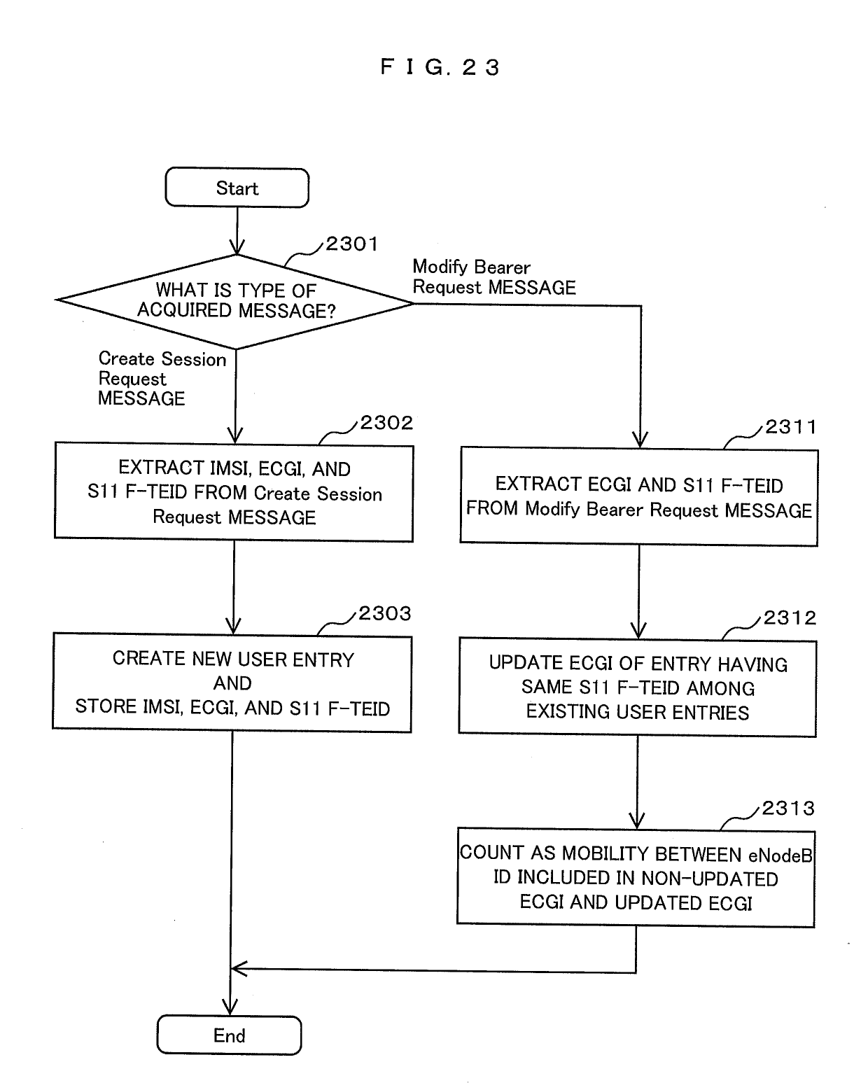

The mobility count process performed in step 2101 will be described with reference to FIG. 23. As described above, the traffic management server hardly detects a movement of the user within the same C-RAN (or the eNodeB) but easily detect a movement of the user between the different C-RANs (or the different eNodeBs) or between the C-RAN and the eNodeB. The detecting of the movement of the user between the different C-RANs (or the different eNodeBs) or between the C-RAN and the eNodeB is implemented by acquiring signaling of the core network through the probe device. The specific method has been described above in the first embodiment, and the details are explicitly illustrated in FIGS. 3 and 5. The mobility count process is implemented by adding a counting step to the process of FIG. 5. FIG. 23 is a flowchart of the mobility count process performed by the traffic management server. The process of step 2301 to step 2303 and the process of step 2311 and step 2312 are the same as the process of step 501 to step 503 and the process of step 511 and step 512 of FIG. 5 except that the S1-U F-TEID is stored, and thus a description thereof is omitted. The storing of the S1-U F-TEID in FIG. 5 is performed for user identification of traffic on the S1-U interface, and unnecessary in the mobility count process of FIG. 23. In step 2313, the traffic management server counts as the user movement between the eNodeB ID extracted from the ECGI before the update of step 2312 and the C-RAN ECGI after the update of step 2312.

In this method, the traffic management server can create the cell cluster without acquiring the information from the EMS. In this method, the cell under control of the C-RAN is classified as the cell cluster for each closest eNodeB. In this method, the traffic management server detects the user location only using the signaling of the S11 interface, and thus it is unnecessary to acquire the signaling of the S1-MME interface.

The procedure in which the traffic management server manages the congestion state and the location of the user in units of cell clusters is the same as the procedure described above with reference to FIG. 3 in the first embodiment, and thus a description thereof is omitted. A difference with the first embodiment lies in the user location information update process performed in sequence 305 and sequence 323 of FIG. 3 and the congestion indicator update process performed in sequence 312 and sequence 332 which will be described later.

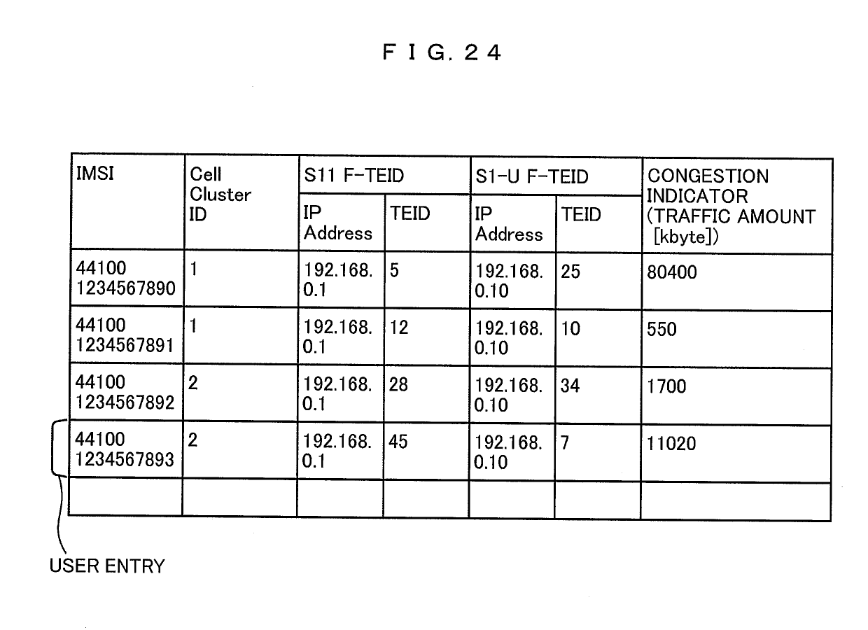

FIG. 24 illustrates the user information table 1111 that stores the user entry including the user location information and the congestion indicator. The user entry includes an IMSI, a cell cluster ID, an S11 F-TEID, an S1-U F-TEID, and a congestion indicator. The S11 F-TEID includes an IP address and a TEID serving as an identifier of the S11 tunnel. The S1-U F-TEID includes an IP address and a TEID serving as an identifier of an S1-U tunnel. The congestion indicator refers to a traffic amount in the example of FIG. 24.

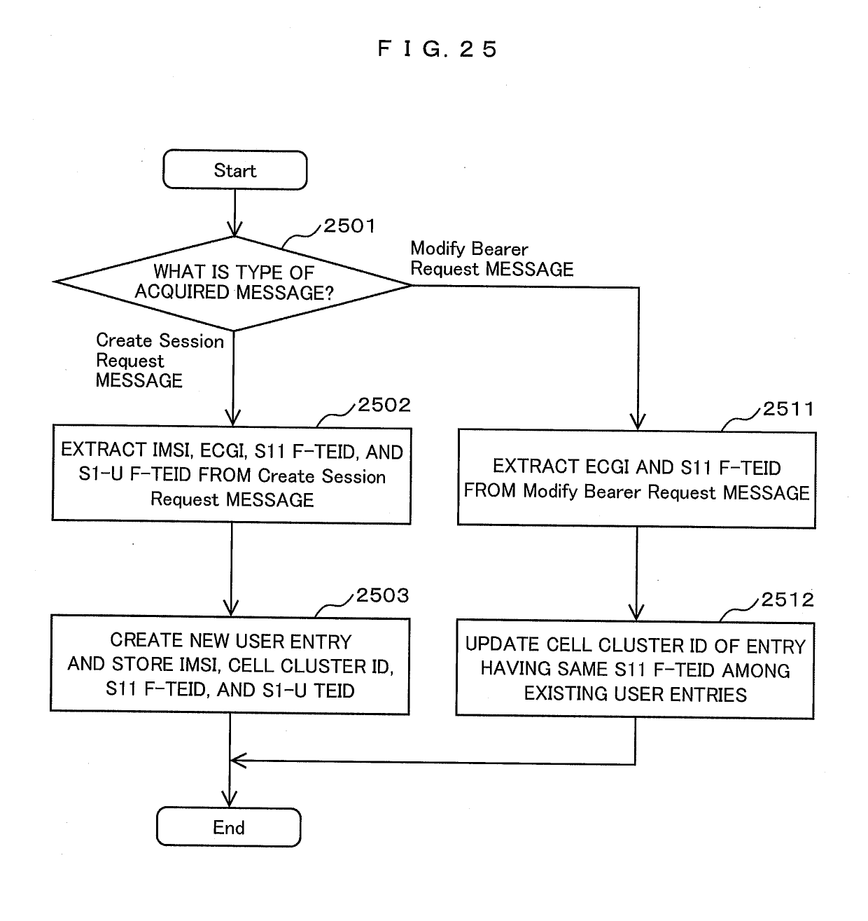

The user location information update process according to the present embodiment will be described with reference to FIG. 25. FIG. 25 is a flowchart illustrating a procedure of the user location information update process performed through the user location information update processing program 1101 executed by the traffic management server. In step 2501, the traffic management server determines whether the message acquired through the probe device is the create session request message or the modify bearer request message. When the message acquired through the probe device is the create session request message, in step 2502, the traffic management server extracts an IMSI serving as a unique user identifier, an ECGI serving as a cell identifier, an S11 F-TEID serving as a user identifier in the S11 interface, and an S1-U F-TEID serving as a user identifier in the S1-U interface from the create session request message. Then, in step S2503, the traffic management server stores the extracted IMSI, the cell cluster ID, the S11 F-TEID, and the S1-U F-TEID in the user information table 1111 as a new user entry. The cell cluster ID is obtained by converting the ECGI extracted in step 2502 with reference to the cell cluster information table 1113.

On the other hand, when the message acquired through the probe device is the modify bearer request message in step 2501, in step 2511, the traffic management server extracts the ECGI and the S11 F-TEID from the modify bearer request message (step 2511). Then, in step 2512, the traffic management server updates the cell cluster ID of the entry having the same S11 F-TEID as the S11 F-TEID extracted in step 2511 among the user entries of the user information table 1111 to the cell cluster ID extracted in step 2511. The cell cluster ID is obtained by converting the ECGI extracted in step 2511 with reference to the cell cluster information table 1113. As described above, the ECGI is extracted from the modify bearer request message transmitted as the UE moves between the different C-RANs or between the C-RAN and the eNodeB or when the UE is activated again, and is converted into the cell cluster ID, and the update is performed using the cell cluster ID. Accordingly, it is possible to manage the location of the user in units of cell clusters.

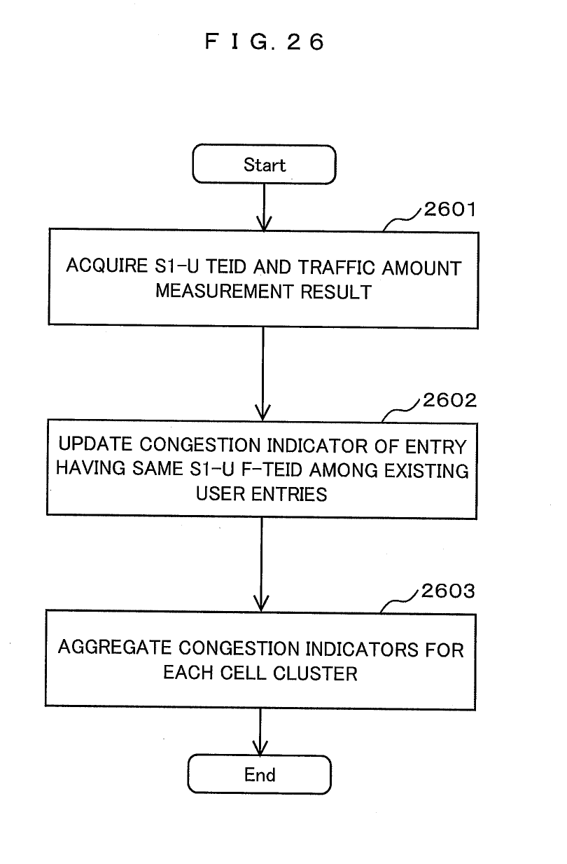

The congestion indicator update process according to the present embodiment will be described with reference to FIG. 26. FIG. 26 is a flowchart illustrating a procedure of the congestion indicator update process performed through the congestion indicator update processing program 1102 executed by the traffic management server. In step 2601, the traffic management server acquires the S1-U TEID and the traffic amount measurement result from the probe device. In step 2602, the traffic management server updates the congestion indicator of the entry having the same S1-U F-TEID as the S1-U F-TEID extracted step 2601 among the user entries of the user information table 1111 to the traffic amount measurement result acquired in step 2601. Further, in step 2603, the traffic management server aggregates the congestion indices of the entries having the same cell cluster ID among the user entries of the user information table 1111, and stores the aggregation result in the congestion indicator table 1112.

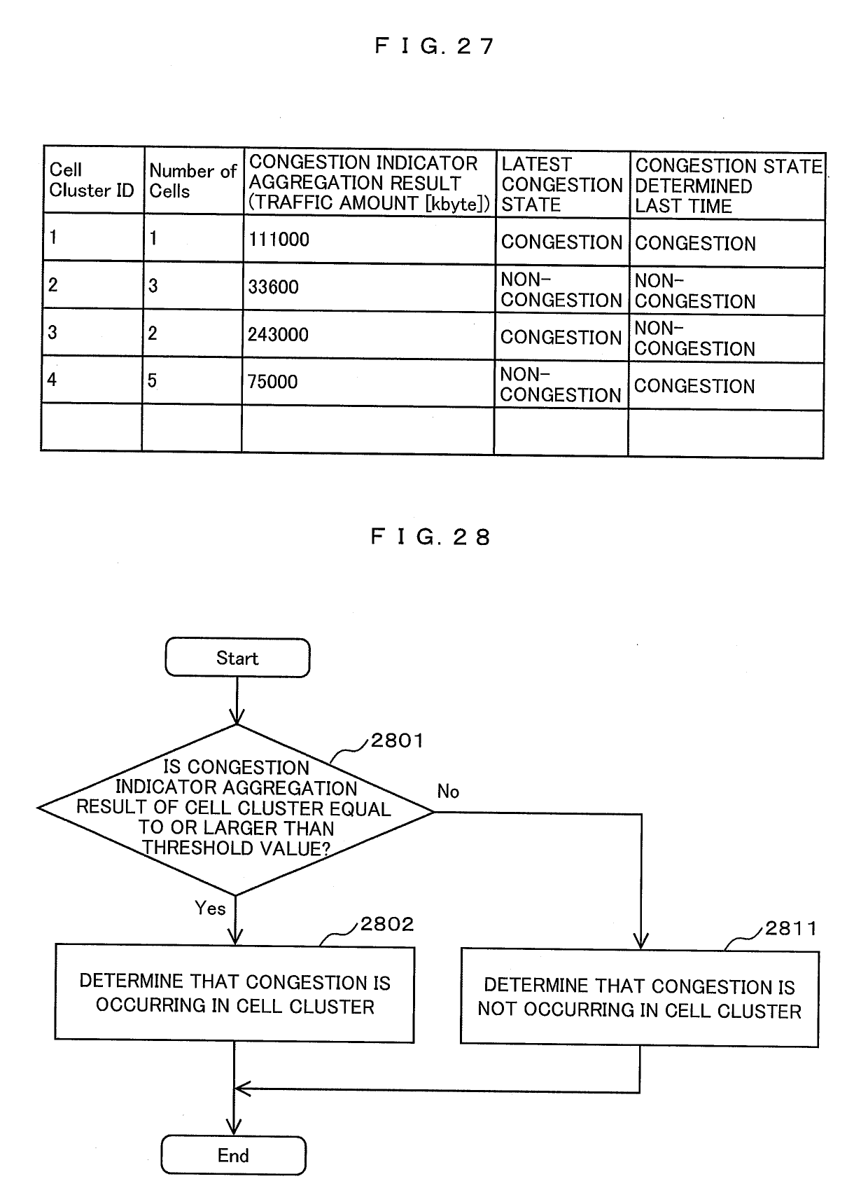

FIG. 27 illustrates the congestion indicator table 1112. The congestion indicator table holds the number of cells included in the cell cluster, the congestion indicator aggregation result, and the congestion state for each cell cluster ID.

Next, a procedure of determining the occurrence of congestion in units of cell clusters through the traffic management server will be described with reference to FIG. 28. FIG. 28 is a flowchart illustrating a procedure of a congestion determination process performed through the congestion determination processing program 1103 executed by the traffic management server. In step 2801, the traffic management server determines whether or not the congestion indicator aggregation result of the cell cluster stored in the congestion indicator table 1112 is larger than a threshold value. For example, the threshold value used in step 2801 may be set in advance by a network administrator or may be set by the traffic management server. Further, the threshold value used in step 2801 may be set according to the number of cells included in the cell cluster for each cell cluster. For example, when a threshold value when the number of cells included in the cell cluster is 1 is assumed to be Th1, a threshold value when the number of cells included in the cell cluster is N is preferably set to N times of Th1. Thus, the congestion determination can be flexibly performed according to the number of cells included in the cell cluster. When the congestion indicator aggregation result of the cell cluster is larger than the threshold value (Yes in step 2801), in step 2802, the traffic management server determines that congestion is occurring in the cell cluster, and sets the congestion state of the cell cluster in the congestion indicator table 1112 to “congestion.” When the congestion indicator aggregation result of the cell cluster is not larger than the threshold value (No in step 2801), in step 2811, the traffic management server determines that congestion is not occurring in the cell cluster, and sets the congestion state of the cell cluster in the congestion indicator table 1112 to “non-congestion.” This process is performed on each of the cell clusters managed through the congestion indicator table 1112. The congestion indicator table 1112 further holds a latest congestion determination result and an immediately previous congestion determination result. The determining of the occurrence of congestion is preferably performed, for example, with a certain time period.

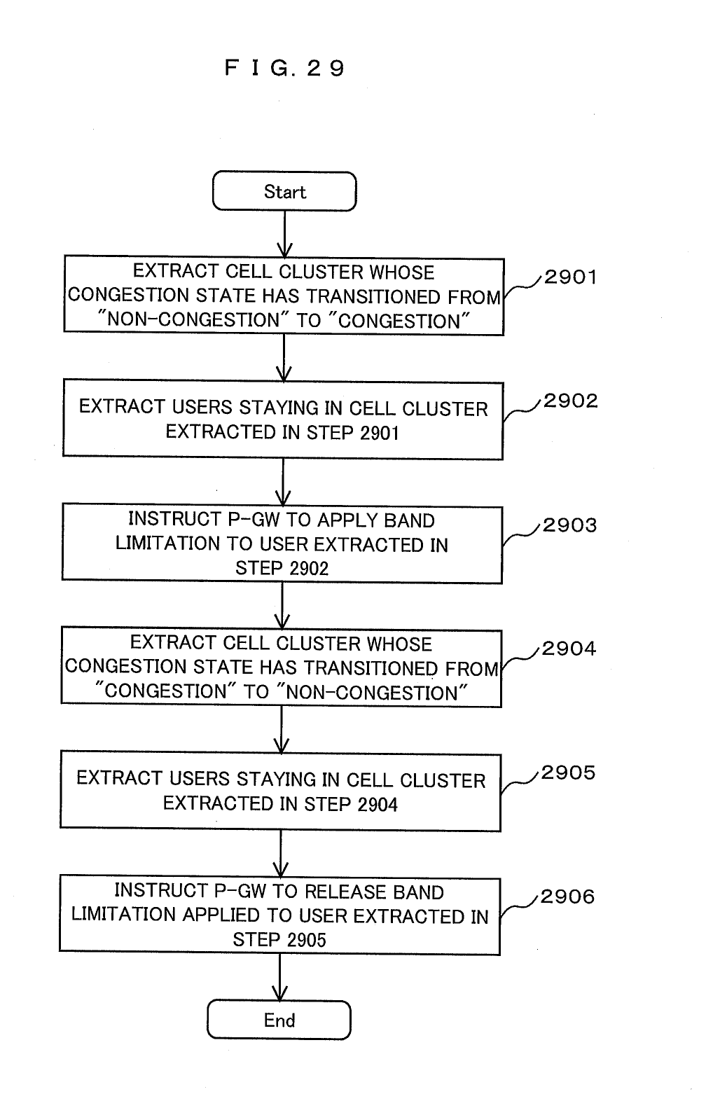

A procedure in which the traffic management server instructs the control device configuring the cellular communication system to identify a terminal staying in a cell cluster in which congestion is occurring and limit a maximum usable bandwidth of the specified terminal will be described with reference to FIG. 29. FIG. 29 is a flowchart illustrating a procedure of a band limitation instruction process performed through the band limitation instruction processing program 1104 executed by the traffic management server. In step 2901, the traffic management server extracts a cell cluster whose congestion state has transitioned from “non-congestion” to “congestion” with reference to the latest congestion state and the congestion state determined last time in the congestion indicator table 1112. Then, in step 2902, the traffic management server extracts a user (an IMSI) staying in the cell cluster (the cell cluster that has entered the congestion state) extracted in step 2901 with reference to the user information table 1111. In step 2903, the traffic management server instructs the P-GW to apply the band limitation to the user (the IMSI) extracted in step 2902. For example, the applying of the band limitation is performed by setting a maximum bit rate allowed to the user. Alternatively, when the maximum bit rate is set even in the non-congestion state, the band limitation is performed by setting a maximum bit rate of a smaller value. Further, in step 2904, the traffic management server extracts a cell cluster whose congestion state has transitioned from “congestion” to “non-congestion” with reference to the latest congestion state and the congestion state determined last time in the congestion indicator table 1112. Then, in step 2905, the traffic management server extracts a user (an IMSI) staying in the cell cluster (the cell cluster that has entered the non-congestion state) extracted in step 2904 with reference to the user information table 1111. In step 2906, the traffic management server instructs the P-GW to release the band limitation applied to the user (the IMSI) extracted in step 2905.

In the above description, the traffic management server extracts the information element from the message, but the probe device may extract the information element and then transfer the extracted information to the traffic management server.

Further, in the above description, the downlink traffic amount is used as the congestion indicator, but any other index may be used. For example, a transmission delay amount, a data rate, or the number of connected users may be used as the congestion indicator. For example, the probe device can acquire the transmission delay amount, the data rate, or the number of connected users by monitoring traffic on the S1-U interface. Alternatively, information related to uplink traffic may be used as the congestion indicator.

Further, in the above description, two levels of states, that is, “congestion” and “non-congestion” are used as the congestion state, but three or more levels of congestion states may be defined. When three or more levels of congestion states are defined, a different upper limit value can be used in subsequent band limitation according to a degree of congestion of a cell. For example, a maximum bit rate allowed to the user when a degree of congestion is low is set to a value larger than a maximum bit rate allowed to the user when a degree of congestion is high. As a result, it is possible to slow down a change in the maximum bit rate associated with a variation in the congestion state and thus prevent the band limitation from affecting a user service.

Further, in the above description, the band limitation is applied to all the users staying in the cell cluster in which congestion is occurring, but the band limitation may be applied to some users. For example, a preferred user may be registered in a traffic management device in advance, and the traffic management device may exclude the preferred user from the band limitation target. Alternatively, a specific traffic type that is desired to be subject to the band limitation may be registered in the traffic management device in advance, and the traffic management device may set only the user that is performing transmission and reception of the specific traffic type as the band limitation target.

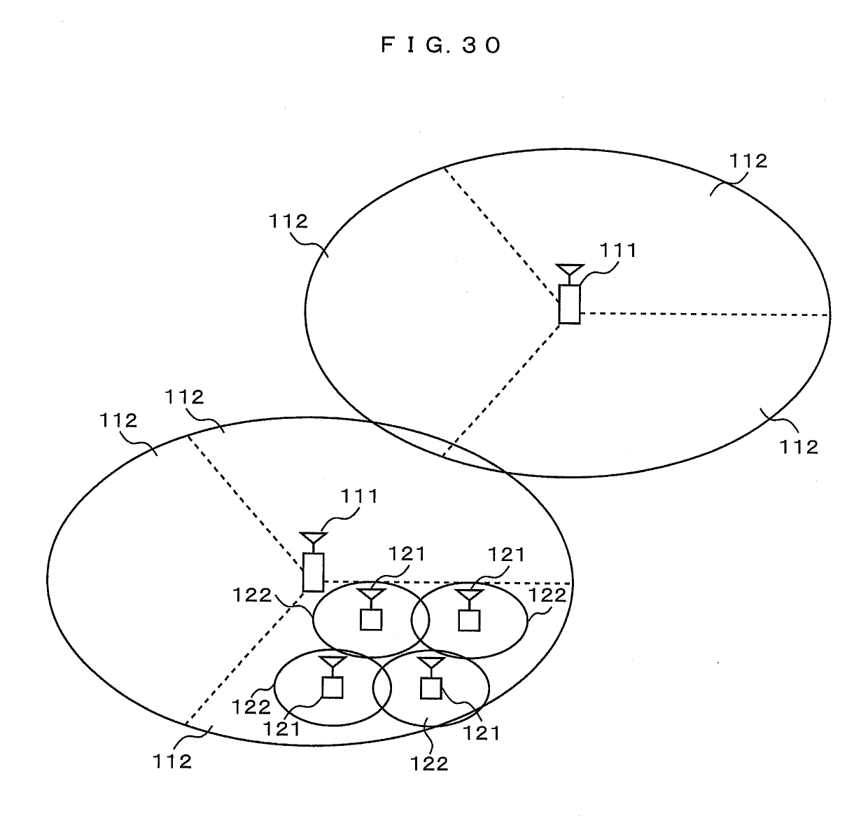

The user location information management, the congestion determination, and the band limitation performed for each cell which are described above in the first embodiment are effective, for example, particularly in the cell arrangement of FIG. 1 as described above. On the other hand, as described above, the traffic management server hardly acquires the user movement within the same C-RAN. For example, when the cells 122 under control of the C-RAN are arranged to be adjacent as illustrated in FIG. 30, the user movement within the C-RAN frequently occurs, and thus if the first embodiment is applied, there are cases in which the band limitation is performed on the cell different from the cell in which congestion is actually occurring, and there are cases in which congestion is not solved although the band limitation is performed. According to the present embodiment, the user location information management, the congestion determination, and the band limitation are performed for each cell cluster, and thus even in the cell arrangement of FIG. 30, it is possible to perform the band limitation on the cell cluster in which congestion is actually occurring, and it is possible to perform effective congestion control.

1. A traffic management server in a cellular communication system including a C-RAN that includes a plurality of wireless transceiving devices performing communication with terminals and arranged to be geographically apart and a processing device connected to the plurality of wireless transceiving devices, the traffic management server instructing a control device configuring the cellular communication system to:
acquire location information of the terminal in a cell of each of the plurality of wireless transceiving devices using a first message between network nodes constituting the cellular communication system;
acquire a congestion indicator of the cell using a second message between the network nodes constituting the cellular communication system;
determine an occurrence of congestion of the cell based on the congestion indicator;
identify a terminal staying in a cell in which the congestion is occurring based on the location information of the terminal; and
limit a maximum usable bandwidth of the identified terminal.

2. A traffic management server in a cellular communication system including a C-RAN that includes a plurality of wireless transceiving devices performing communication with terminals and arranged to be geographically apart and a processing device connected to the plurality of wireless transceiving devices, the traffic management server instructing a control device configuring the cellular communication system to:
group cells that belong to the same C-RAN, are formed by the plurality of wireless transceiving devices, and are geographically adjacent as a cell cluster;
acquire location information of the terminal in the cell cluster using a first message between network nodes constituting the cellular communication system;
acquire a congestion indicator of the cell cluster using a second message between the network nodes constituting the cellular communication system;
determine an occurrence of congestion of the cell cluster based on the congestion indicator;
identify a terminal staying in a cell cluster in which the congestion is occurring based on the location information of the terminal; and
limit a maximum usable bandwidth of the identified terminal.

3. The traffic management server according to claim 2,
wherein adjacent cell information is held for each of the cells formed by the plurality of wireless transceiving devices, and
when grouping for the cell cluster is performed, cells belonging to the same C-RAN as a certain cell among cells included in the adjacent cell information of the certain cell are grouped as the same cell cluster as the certain cell.

4. The traffic management server according to claim 2,
wherein handover history information including information of a cell in which the terminal has stayed is held, and
when grouping for the cell cluster is performed, if two cells before and after a handover among cells included in the handover history information belong to the same C-RAN, the two cells are grouped as the same cell cluster.

5. The traffic management server according to claim 2,
wherein the number of movements of the terminal occurred between a group of cells belonging to the C-RAN and a group of base stations is counted, and
when grouping for the cell cluster is performed, cells having the large number of movements with the same base station included in the group of base stations among the group of cells and belonging to the same C-RAN are grouped as the same cell cluster.

6. The traffic management server according to claim 2,
wherein a determination threshold value used to determine an occurrence of congestion in the cell cluster is held for each cell cluster, and
the determination threshold value is decided based on the number of cells included in the cell cluster.

7. A management program executed by a traffic management server in a cellular communication system including a C-RAN that includes a plurality of wireless transceiving devices performing communication with terminals and arranged to be geographically apart and a processing device connected to the plurality of wireless transceiving devices, the management program instructing a control device configuring the cellular communication system to:
acquire location information of the terminal in a cell of each of the plurality of wireless transceiving devices using a first message between network nodes constituting the cellular communication system;
acquire a congestion indicator of the cell using a second message between the network nodes constituting the cellular communication system;
determine an occurrence of congestion of the cell based on the congestion indicator;
identify a terminal staying in a cell in which the congestion is occurring based on the location information of the terminal; and
limit a maximum usable bandwidth of the specified terminal.

8. A management program executed by a traffic management server in a cellular communication system including a C-RAN that includes a plurality of wireless transceiving devices performing communication with terminals and arranged to be geographically apart and a processing device connected to the plurality of wireless transceiving devices, the management program instructing a control device configuring the cellular communication system to:
group cells that belong to the same C-RAN, are formed by the plurality of wireless transceiving devices, and are geographically adjacent as a cell cluster;
acquire location information of the terminal in the cell cluster using a first message between network nodes constituting the cellular communication system;
acquire a congestion indicator of the cell cluster using a second message between the network nodes constituting the cellular communication system;
determine an occurrence of congestion of the cell cluster based on the congestion indicator;
identify a terminal staying in a cell cluster in which the congestion is occurring based on the location information of the terminal; and
limit a maximum usable bandwidth of the specified terminal.

9. The management program according to claim 8,
wherein adjacent cell information of each of the cells formed by the plurality of wireless transceiving devices is held in the traffic management server, and
when grouping for the cell cluster is performed, cells belonging to the same C-RAN as a certain cell among cells included in the adjacent cell information of the certain cell are grouped as the same cell cluster as the certain cell.

10. The management program according to claim 8,
wherein handover history information including information of a cell in which the terminal has stayed is held in the traffic management server, and
when grouping for the cell cluster is performed, if two cells before and after a handover among cells included in the handover history information belong to the same C-RAN, the two cells are grouped as the same cell cluster.

11. The management program according to claim 8,
wherein the number of movements of the terminal occurred between a group of cells belonging to the C-RAN and a group of base stations is counted, and
when grouping for the cell cluster is performed, cells having the large number of movements with the same base station included in the group of base stations among the group of cells belonging to the same C-RAN are grouped as the same cell cluster.

12. The management program according to claim 8,
wherein a determination threshold value used to determine an occurrence of congestion in the cell cluster is decided for each cell cluster based on the number of cells included in the cell cluster.
